(19) United States
(12) Patent Application Publication
(10) Pub. No.: US 2025/0373851 A1
(43) Pub. Date: Dec. 4, 2025

(54) POINT CLOUD PROCESSING

(71) Applicant: TENCENT TECHNOLOGY (SHENZHEN) COMPANY LIMITED, Shenzhen (CN)

(72) Inventor: Wenjie ZHU, Shenzhen (CN)

(73) Assignee: TENCENT TECHNOLOGY (SHENZHEN) COMPANY LIMITED, Shenzhen (CN)

(21) Appl. No.: 19/300,608

(22) Filed: Aug. 14, 2025

Related U.S. Application Data
(63) Continuation of application No. PCT/CN2024/091165, filed on May 6, 2024.

(30) Foreign Application Priority Data
May 31, 2023 (CN) 202310643886.0

(51) Int. Cl. H04N 19/597; H04N 19/124; H04N 19/136; H04N 19/172; H04N 19/174; H04N 19/91

(52) U.S. Cl. CPC H04N 19/597; H04N 19/124; H04N 19/136; H04N 19/172; H04N 19/174; H04N 19/91

(57) ABSTRACT

A method of point cloud processing is provided. In some examples, a point cloud code stream of a point cloud having a plurality of point cloud frames is obtained. The point cloud code stream includes decoding indication information that provides decoding information for different element levels of the point cloud, the different element levels of the point cloud include at least one of: a point cloud frame level and a point cloud slice level. The decoding indication information includes a decoding of a cross-type attribute prediction parameter based on an attribute encoding order field. The point cloud code stream is decoded based on the decoding indication information. Apparatus and non-transitory computer-readable storage medium counterpart embodiments are also contemplated.

### RELATED APPLICATIONS

The present application is a continuation of International Application No. PCT/CN2024/091165, filed on May 6, 2024, which claims priority to Chinese Patent Application No. 202310643886.0, filed on May 31, 2023. The entire disclosures of the prior applications are hereby incorporated by reference.

### FIELD OF THE TECHNOLOGY

This application relates to the field of computer technologies, including a point cloud processing method and apparatus, a computer device, and a storage medium.

### BACKGROUND OF THE DISCLOSURE

With the continuous development of science and technology, a large number of high-precision point clouds can be obtained currently at low costs and in a short period of time. A point cloud may include a plurality of points, and each point in the point cloud has geometry information and attribute information. To improve transmission efficiency of the point cloud, it is usually necessary to encode the point cloud before transmission of the point cloud. In an example, an encoder may encode the geometry information and the attribute information of each point in the point cloud, and then transmit the encoded point cloud to a decoder, and the decoder may decode the encoded point cloud, to reconstruct the geometry information and the attribute information of each point in the point cloud. Generally, a data volume of the attribute information of each point in the point cloud is relatively large, and a large amount of attribute information causes pressure during decoding, resulting in low decoding performance of the point cloud. Therefore, how to improve the decoding performance of the point cloud has become a current research hotspot.

### SUMMARY

Embodiments of this disclosure provide a point cloud processing method and apparatus, a computer device, and a storage medium, to improve decoding performance of a point cloud.

Some aspects of the disclosure provide a method of point cloud processing. In some examples, a point cloud code stream of a point cloud having a plurality of point cloud frames is obtained. The point cloud code stream includes decoding indication information that provides decoding information for different element levels of the point cloud, the different element levels of the point cloud include at least one of: a point cloud frame level and a point cloud slice level. The decoding indication information includes a decoding of a cross-type attribute prediction parameter based on an attribute encoding order field. The point cloud code stream is decoded based on the decoding indication information.

Some aspects of the disclosure provide an apparatus that includes processing circuitry configured to perform the method of point cloud processing.

Some aspects of the disclosure also provide a non-transitory computer-readable storage medium storing instructions which when executed by at least one processor cause the at least one processor to perform the method of point cloud processing.

According to an aspect, an embodiment of this disclosure provides a point cloud processing method, the point cloud processing method including: obtaining a point cloud code stream, the point cloud code stream including decoding indication information, the decoding indication information being configured for performing decoding indication on different types of data in a point cloud, the different types of data including at least one of the following: a point cloud frame and a point cloud slice; and decoding the point cloud based on the decoding indication information.

Correspondingly, an embodiment of this disclosure provides a point cloud processing apparatus, the point cloud processing apparatus including: an obtaining unit, configured to obtain a point cloud code stream, the point cloud code stream including decoding indication information, the decoding indication information being configured for performing decoding indication on different types of data in a point cloud, the different types of data including at least one of the following: a point cloud frame and a point cloud slice; and a processing unit, configured to decode the point cloud based on the decoding indication information.

According to another aspect, an embodiment of this disclosure provides a point cloud processing method, the point cloud processing method including: generating decoding indication information, and encoding the decoding indication information into a point cloud code stream, the decoding indication information being configured for performing decoding indication on different types of data in a point cloud, the different types of data including at least one of the following: a point cloud frame and a point cloud slice; and transmitting the point cloud code stream to a decoding device, so that the decoding device decodes the point cloud based on the decoding indication information.

Correspondingly, an embodiment of this disclosure provides a point cloud processing apparatus, the point cloud processing apparatus including: a processing unit, configured to generate the decoding indication information, and encode the decoding indication information into a point cloud code stream, the decoding indication information being configured for performing decoding indication on different types of data in a point cloud, the different types of data including at least one of the following: a point cloud frame and a point cloud slice; and a communication unit, configured to transmit the point cloud code stream to a decoding device, so that the decoding device decodes the point cloud based on the decoding indication information.

Correspondingly, an embodiment of this disclosure provides a computer program product, the computer program product including a computer instruction, the computer instruction being stored in a computer-readable storage medium (e.g., non-transitory computer-readable storage medium). A processor (an example of processing circuitry) of a computer device reads the computer instruction from the computer-readable storage medium, and the processor executes the computer instruction, so that the computer device performs the foregoing point cloud processing method.

In the embodiments of this disclosure, the decoding indication information in the point cloud code stream may be configured for performing decoding indication on different types of data in a point cloud, the different types of data including at least one of the following: a point cloud frame and a point cloud slice. Therefore, the point cloud is decoded based on the decoding indication information through a decoding indication function of the decoding indication information for different types of data in a point cloud, to improve decoding performance of the point cloud.

### BRIEF DESCRIPTION OF THE DRAWINGS

FIG. 1 is a schematic diagram of an encoding framework of point cloud compression (PCC) according to an embodiment of this disclosure.

FIG. 2 is a schematic diagram of an architecture of a point cloud processing system according to an embodiment of this disclosure.

FIG. 3 is a schematic flowchart of a point cloud processing method according to an embodiment of this disclosure.

FIG. 4 is a schematic flowchart of another point cloud processing method according to an embodiment of this disclosure.

FIG. 5 is a schematic structural diagram of a point cloud processing apparatus according to an embodiment of this disclosure.

FIG. 6 is a schematic structural diagram of another point cloud processing apparatus according to an embodiment of this disclosure.

FIG. 7 is a schematic structural diagram of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

(1) Point cloud: The point cloud refers to a set of irregularly distributed discrete points in space that express a spatial structure and surface attributes of a three-dimensional object or a three-dimensional scene. Point clouds may be divided into different categories based on different classification standards. For example, the point clouds may be divided into dense point clouds and sparse point clouds based on obtaining manners of the point clouds. For another example, the point clouds may be divided into static point clouds and dynamic point clouds based on timing types of the point clouds.

(2) Point cloud data: Geometry information and attribute information of each point in a point cloud jointly constitute the point cloud data. The geometry information may also be referred to as three-dimensional position information. Geometry information of a certain point in the point cloud refers to spatial coordinates (x, y, z) of the point, and may include coordinate values of the point in each coordinate axis direction of a three-dimensional coordinate system, for example, a coordinate value x in an X-axis direction, a coordinate value y in a Y-axis direction, and a coordinate value z in a Z-axis direction. Attribute information of a certain point in the point cloud may include at least one of the following: color information, material information, and laser reflection intensity information (which may also be referred to as a reflectance). Generally, each point in the point cloud has the same amount of attribute information. For example, each point in the point cloud may have two types of attribute information including the color information and the laser reflection intensity information. For another example, each point in the point cloud may have three types of attribute information including the color information, the material information, and the laser reflection intensity information.

(3) Point cloud compression (PCC): The PCC is a process of encoding geometry information and attribute information of each point in a point cloud to obtain a compressed code stream (which may also be referred to as a point cloud code stream). The PCC may include two main processes: geometry information encoding and attribute information encoding. Current mainstream PCC technologies may be divided into geometry-based PCC and projection-based PCC based on different types of point clouds. Geometry-based PCC (G-PCC) in the moving picture expert group (MPEG) and the PCC standard audio video coding standard (AVS)-PCC in the AVS are used as examples for description herein.

Encoding frameworks of the G-PCC and the AVS-PCC are approximately the same. The G-PCC is used as an example. FIG. 1 shows an encoding framework of the G-PCC, which may be divided into a geometry information encoding process and an attribute information encoding process. In the geometry information encoding process, geometry information of each point in a point cloud is encoded to obtain a geometric bit stream. In the attribute information encoding process, attribute information of each point in the point cloud is encoded to obtain an attribute bit stream. The geometric bit stream and the attribute bit stream jointly constitute a compressed code stream of the point cloud.

For main operations and processing of the geometry information encoding process, reference may be made to the following description.

\textcircled{1} Pre-processing: The pre-processing may include coordinate transformation and voxelization. Through operations of scaling and translation, point cloud data in a three-dimensional space is converted into an integer form, and a minimum geometric position of the point cloud data is moved to a coordinate origin.

\textcircled{2} Geometry encoding: The geometry encoding may include two modes, which are respectively octree-based geometry encoding and trisoup-based geometry encoding. The two encoding modes may be used under different conditions.

Octree-based geometry encoding: An octree is a tree data structure. In three-dimensional space division, a preset bounding box is evenly divided, and each node has eight child nodes. “1” and “0” are adopted to indicate whether each child node of the octree is occupied or not, to obtain occupancy code information as a code stream of geometry information in a point cloud.

Trisoup-based geometry encoding: The trisoup-based geometry encoding is dividing a point cloud into blocks of a certain size, locating intersection points of a surface of the point cloud at edges of the blocks, and constructing a triangle. The positions of the intersection points are encoded to implement compression of geometry information.

\textcircled{3} Geometry quantization: Fineness of quantization is generally determined by a quantization parameter (QP). A larger QP indicates that coefficients with a larger value range are to be quantized to the same output, which usually brings greater distortion and a lower bit rate. On the contrary, a smaller QP indicates that coefficients within a smaller value range are to be quantized to the same output, which usually brings less distortion and a higher bit rate.

\textcircled{4} Geometry entropy encoding: Statistical compression encoding is performed on the occupancy code information of the octree, and finally a binarized (0 or 1) compressed bit stream is outputted. Statistical encoding is a lossless encoding manner that may effectively reduce a bit rate required to express the same signal. A commonly used statistical encoding manner is content-based adaptive binary arithmetic coding (CABAC).

For main operations and processing of the attribute information encoding process, reference may be made to the following description.

\textcircled{1} Attribute recoloring: In the case of lossy encoding, after geometric coordinate information is encoded, an encoder needs to decode and reconstruct geometry information, namely, restore geometry information of each point in a point cloud. The original point cloud is searched for attribute information corresponding to one or more proximal points as attribute information of the reconstructed point.

\textcircled{2} Attribute information processing: The attribute information processing may include three attribute encoding modes, which are respectively attribute prediction, attribute transformation, and attribute prediction & transformation. The three attribute encoding modes may be used under different conditions.

Attribute prediction: A neighbor prediction point of a to-be-encoded point is determined in encoded points based on information such as a distance or a spatial relationship, and attribute prediction information of the to-be-encoded point is calculated based on attribute information of the neighbor prediction point according to a set criterion. A difference between real attribute information and predicted attribute information of the to-be-encoded point is calculated as attribute residual information, and quantization and entropy encoding are performed on the attribute residual information.

Attribute transformation: Attribute information is grouped and transformed through a transformation method such as discrete cosine transform (DCT) or Haar transform, to obtain a transformation coefficient, and quantization and entropy encoding are performed on the transformation coefficient.

Attribute prediction and transformation: The preceding operation is the same as attribute prediction. After the attribute residual information of the to-be-encoded point is obtained, and the attribute residual information of the to-be-encoded point is transformed through a transformation algorithm to obtain a transformation coefficient, quantization and entropy encoding are performed on the transformation coefficient.

\textcircled{3} Attribute information quantization: Fineness of quantization is usually determined by a QP. Quantization is performed on a transformation coefficient and/or attribute residual information obtained by processing the attribute information, and entropy encoding is performed on a result of quantization. For example, during attribute prediction, entropy encoding is performed on quantized attribute residual information. In attribute transformation and attribute prediction and transformation, entropy encoding is performed on the quantized transformation coefficient.

\textcircled{1} Attribute entropy encoding: The quantized attribute residual information and/or transformation coefficient is finally compressed generally through entropy encoding methods such as run length encoding and arithmetic coding. In a corresponding attribute encoding mode, information such as a QP is also encoded through an entropy encoder.

(4) Point cloud decoding: The point cloud decoding is a process of decoding a compressed bit stream obtained through PCC, to reconstruct a point cloud. In detail, a geometric bit stream in a compressed bit stream is parsed, geometry information of each point in a point cloud is reconstructed, an attribute bit stream in a compressed bit stream is parsed, and attribute information of each point in a point cloud is reconstructed. A decoding process of the point cloud in an attribute prediction mode and an attribute prediction and transformation mode is described in detail herein.

In the attribute prediction mode, quantized attribute residual information of a to-be-decoded point may be obtained from the attribute bit stream through entropy decoding, and inverse quantization is performed on the quantized attribute residual information to obtain attribute residual information of the to-be-decoded point. A neighbor prediction point of a to-be-decoded point is determined in decoded points based on information such as a distance or a spatial relationship, and attribute prediction information of the to-be-decoded point is calculated based on attribute reconstruction information of the neighbor prediction point according to a set criterion. The attribute information (which may be referred to as attribute reconstruction information) of the to-be-decoded point may be reconstructed based on the attribute residual information of the to-be-decoded point and the attribute prediction information of the to-be-decoded point.

In the attribute prediction and transformation mode, a quantized transformation coefficient of a to-be-decoded point may be obtained from the attribute bit stream through entropy decoding, inverse quantization is performed on the quantized transformation coefficient to obtain a transformation coefficient, and inverse transformation is performed on the transformation coefficient to obtain attribute residual information of the to-be-decoded point. A neighbor prediction point of a to-be-decoded point is determined in decoded points based on information such as a distance or a spatial relationship, and attribute prediction information of the to-be-decoded point is calculated based on attribute reconstruction information of the neighbor prediction point according to a set criterion. The attribute information (which may be referred to as attribute reconstruction information) of the to-be-decoded point may be reconstructed based on the attribute residual information of the to-be-decoded point and the attribute prediction information of the to-be-decoded point.

Based on the foregoing descriptions of the basic concepts, an embodiment of this disclosure provides a point cloud processing method. Through the point cloud processing method, in an attribute decoding stage of a point cloud, an obtained point cloud code stream may include decoding indication information, the decoding indication information may be configured for performing decoding indication on different types of data in the point cloud, and the point cloud may be decoded based on the decoding indication information. Through the point cloud processing method, in an attribute encoding stage of the point cloud, decoding indication information may be generated, the decoding indication information is encoded into a point cloud code stream, and the point cloud code stream is transmitted to a decoding device, so that the decoding device decodes the point cloud based on the decoding indication information. Through the point cloud processing method, the point cloud is decoded based on the decoding indication information through a decoding indication function of the decoding indication information for different types of data in a point cloud, to improve decoding performance of the point cloud.

A point cloud processing system adapted to implement the point cloud processing method provided in the embodiments of this disclosure is described below with reference to the accompanying drawings.

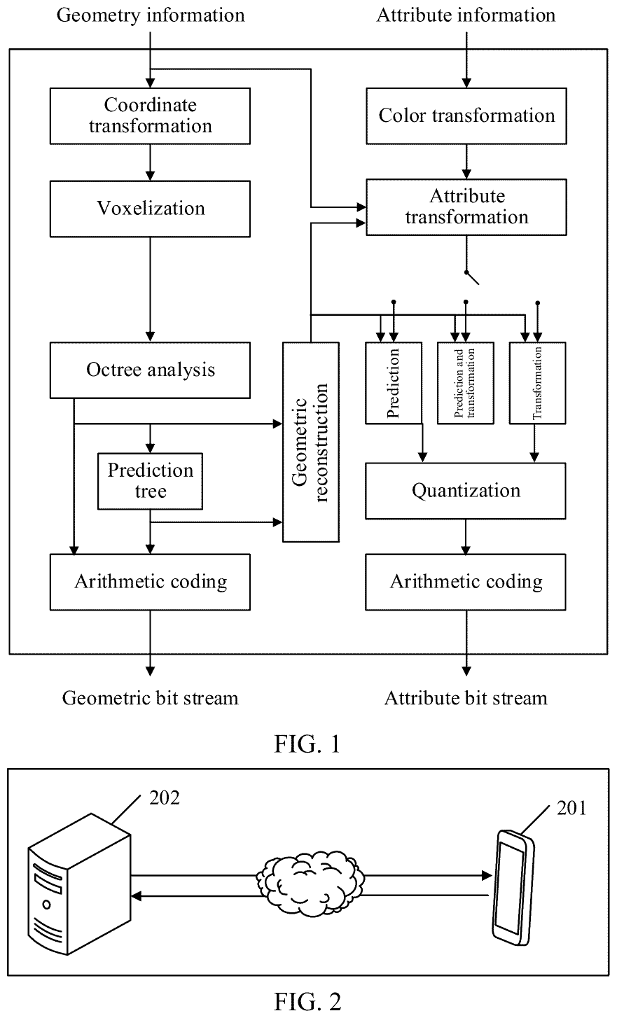

As shown in FIG. 2, the point cloud processing system may include an encoding device 201 and a decoding device 202. The encoding device 201 may be a terminal or a server, and the decoding device 202 may be a terminal or a server. A direct communication connection may be established between the encoding device 201 and the decoding device 202 through wired communication, or an indirect communication connection may be established therebetween through wireless communication. The terminal may be a smartphone, a tablet computer, a notebook computer, a desktop computer, an intelligent voice interaction device, a smartwatch, an on-board terminal, an intelligent home appliance, an aircraft, or the like, but is not limited thereto. The server may be an independent physical server, or may be a server cluster formed by a plurality of physical servers, or a distributed system, and may further be a cloud server that provides basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform.

### (1) For the Encoding Device 201:

The encoding device 201 may obtain point cloud data (namely, geometry information and attribute information of each point in a point cloud). The point cloud data may be captured from a scene or generated by a device. The capturing point cloud data from a scene means collecting a visual scene of the real world through a capture device associated with the encoding device 201, to obtain point cloud data. The capture device is configured to provide a point cloud data obtaining service for the encoding device 201. The capture device may include, but is not limited to any one of the following: a camera device, a sensing device, and a scanning device. The camera device may include an ordinary camera, a stereo camera, a light field camera, or the like. The sensing device may include a laser device, a radar device, or the like. The scanning device may include a three-dimensional laser scanning device, or the like. The capture device associated with the encoding device 201 may be a hardware component arranged in the encoding device 201. For example, the capture device is a camera or a sensor of the terminal. The capture device associated with the encoding device 201 may also be a hardware apparatus connected to the encoding device 201, for example, a camera connected to a server. The generating the point cloud data by the device means that the encoding device 201 generates the point cloud data based on a virtual object (for example, a virtual three-dimensional object and a virtual three-dimensional scene that are obtained through three-dimensional modeling).

The encoding device 201 may encode geometry information and attribute information of each point in the point cloud to obtain a point cloud code stream. The encoding device 201 may transmit the point cloud code stream obtained through encoding to the decoding device 202 together. Particularly, in a PCC process, the encoding device 201 may generate decoding indication information, encode the decoding indication information into a point cloud code stream (including a geometric bit stream and an attribute bit stream), and transmit the point cloud code stream to the decoding device 202. The decoding indication information may be configured for performing decoding indication on different types of data in a point cloud, so that the decoding device 202 may decode the point cloud based on a decoding indication function of the decoding indication information for the different types of data in the point cloud, thereby improving decoding performance of the point cloud.

### (2) For the Decoding Device 202:

The decoding device 202 may receive the point cloud code stream (including an attribute bit stream and a geometric bit stream) transmitted by the encoding device 201, and then decode the point cloud code stream to reconstruct geometry information (which may be referred to as geometric reconstruction information) and attribute information (which may be referred to as attribute reconstruction information) of each point in the point cloud. Particularly, in a point cloud decoding process, the decoding device 202 may decode the point cloud based on the decoding indication function of the decoding indication information in the point cloud code stream for the different types of data in the point cloud, thereby improving the decoding performance of the point cloud.

The point cloud processing system described in the embodiments of this disclosure is intended to describe the technical solutions in the embodiments of this disclosure, and does not constitute a limitation on the technical solutions provided in the embodiments of this disclosure. It is noted that with the evolution of a system architecture and emergence of new service scenarios, the technical solutions provided in the embodiments of this disclosure are also applicable to similar technical problems.

The point cloud processing method provided in the embodiments of this disclosure is described in more detail below with reference to the accompanying drawings.

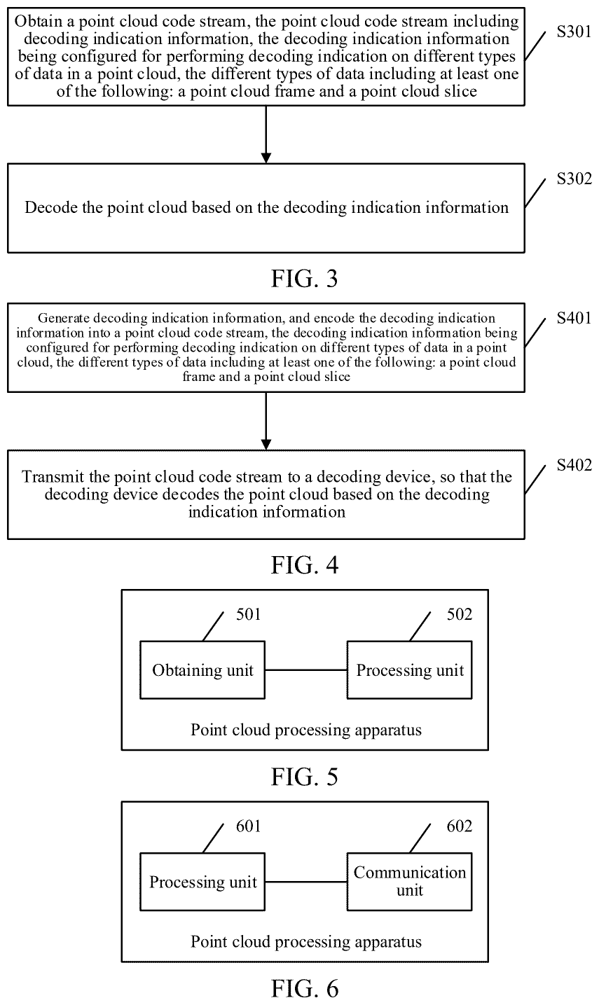

An embodiment of this disclosure provides a point cloud processing method. In the point cloud processing method, a point cloud decoding process is mainly described. The point cloud processing method may be performed by a computer device. The computer device may be the decoding device 202 in the foregoing point cloud processing system. As shown in FIG. 3, the point cloud processing method may include but is not limited to the following operation S301 and operation S302.

S301: Obtain a point cloud code stream, the point cloud code stream including decoding indication information, the decoding indication information being configured for performing decoding indication on different types of data in a point cloud, the different types of data including at least one of the following: a point cloud frame and a point cloud slice.

The point cloud code stream may include decoding indication information, and the decoding indication information may be configured for performing decoding indication on different types of data in a point cloud. In an example, the point cloud decoding information may be set in an attribute header, a frame header, and a slice header. The decoding indication information set in the attribute header may be configured for performing attribute decoding indication on the point cloud frame in a point cloud. The decoding indication information set in the frame header may be configured for performing decoding indication on the point cloud frame in the point cloud. The decoding indication information set in the slice header may be configured for performing decoding indication on the point cloud slice in the point cloud. The decoding indication information set in the attribute header, the frame header, and the slice header is described below.

### I. Decoding Indication Information set in the Attribute Header

A point cloud may include a plurality of point cloud frames, the decoding indication information may be set in an attribute header of each of the point cloud frames, and the attribute header includes a parameter set required to decode attribute information of the point cloud. The decoding indication information set in the attribute header of the point cloud frame may be configured for performing attribute decoding indication on the point cloud frame. The performing attribute decoding indication on the point cloud frame means performing indication on decoding of attribute information of each point in the point cloud frame. Before the decoding indication information set in the attribute header is described, syntax elements of a general attribute header are first described herein. The syntax elements of the general attribute header are shown in Table 1 below:

TABLE 1

| | Descriptor |
|---|---|
| attribute_header( ) { | |
| for (attrIdx = 0;attrIdx<(maxNumAttributesMinus1 + 1);attrIdx ++){ | |
| attributePresentFlag[attrIdx] | u(1) |
| if(attributePresentFlag[attrIdx]){ | |
| attribute_data_num_set_minus1[attrIdx] | ue(v) |
| if(sps_multi_set_flag) | |
| multi_set_flag[attrIdx] | u(1) |
| if(multi_set_flag[attrIdx]) | |
| attribute_info_num_set_minus1[attrIdx] | ue(v) |
| for(i=0;i< (attribute_info_num_set_minus1[attrIdx]+1); i++){ | |
| outputBitDepthMinus1[ attrIdx ][i] | ue(v) |
| if (attrIdx == 0 ∥ attrIdx == 1) { | |
| maxNumOfNeighboursLog2Minus7[attrIdx][i] | u(2) |
| numOflevelOfDetail[attrIdx][i] | ue(v) |
| maxNumOfPredictNeighbours[attrIdx][i] | ue(v) |
| intraLodFlag[attrIdx][i] | u(1) |
| parityBasedLevelCodingEnable[attrIdx][i] | u(1) |
| log2_golomb_group_size[attrIdx][i] | ue(v) |
| } | |
| if (attrIdx == 0) { | |
| cross_component_Pred [i] | u(1) |
| orderSwitch [i] | u(1) |
| chromaQpOffsetCb [i] | se(v) |
| chromaQpOffsetCr [i] | se(v) |
| colorReorderMode [i] | ue(v) |
| colorGolombNum [i] | ue(v) |
| } | |
| if (attrIdx == 1) { | |
| nearestPredParam1 [i] | ue(v) |
| nearestPredParam2 [i] | ue(v) |
| axisBias [i] | ue(v) |
| refReorderMode [i] | ue(v) |
| refGolombNum [i] | ue(v) |
| predFixedPointFracBit [i] | ue(v) |
| log2_pred_dist_weight_group_size[i] | ue(v) |
| } | |
| if (attributePresentFlag[0]&&attributePresentFlag[1]){ | |
| crossAttrTypePred [i] | u(1) |
| if (crossAttrTypePred[i]){ | |
| attrEncodeOrder [i] | u(1) |
| crossAttrTypePredParam1 [i] | u(15) |
| crossAttrTypePredParam2 [i] | u(21) |
| } | |
| } | |
| transform[attrIdx][i] | ue(2) |
| If(transform [attrIdx][i]== 1) { | |
| kFracBits[attrIdx][i] | ue(v) |
| } | |
| if | |
| (transform[attrIdx][i]&&(attributePresentFlag[0]∥attributePresentFlag[1])) { | |
| attrTransformQpDelta[attrIdx][i] | ue(v) |
| transformSegmentSize[attrIdx][i] | ue(v) |
| maxTransNum[attrIdx][i] | ue(v) |
| log2maxNumofCoeffMinus8[attrIdx][i] | ue(v) |
| QpOffsetDC[ attrIdx ][i] | se(v) |
| QpOffsetAC[attrIdx][i] | se(v) |
| transResLayer[attrIdx][i] | u(1) |
| if (attributePresentFlag[0]) { | |
| chromaQpOffsetDC [i] | se(v) |
| chromaQpOffsetAC [i] | se(v) |
| colorInitPredTransRatio [i] | se(v) |
| colorQPAdjustFlag [i] | u(1) |
| if(colorQPAdjustFlag [i]){ | |
| colorQPAdjustScalar [i] | ue(v) |
| } | |
| } | |
| if ( attributePresentFlag[1]) { | |
| RefGroupPred [i] | u(1) |
| refInitPredTransRatio [i] | ue(v) |
| } | |
| log2coeffLengthControlMinus8[attrIdx][i] | ue(v) |
| } | |
| } | |
| } | |
| } | |
| byte_alignment( ) | |
| } | |

The syntax elements in the general attribute header shown in Table 1 above are explained below.

Attribute presence flag field (attributePresentFlag[attrIdx]): It is a binary variable. A value of ‘1’ indicates that a point cloud code stream includes an attrIdx attribute code (namely an attribute code under an attribute type with an attribute index of attrIdx), and a value of ‘0’ indicates that a point cloud code stream does not include the attrIdx attribute code. The attrIdx represents an attribute index, which is an integer between 0 and 15. The meaning is explained in Table 2 below.

TABLE 2

| attrIdx | Attribute description |
|---|---|
| 0 | Color |
| 1 | Reflectance |
| 2 . . . 15 | Reserved |

Attribute data number minus one field (attribute_data_num_set_minus1[attrIdx]): It is an unsigned integer. Plus 1 indicates a number of attribute multiple data sets supported by an attribute determined by the attribute index attrIdx in a point cloud code stream. This is a figure between 0 and 127. When attribute_data_num_set_minus1 [attrIdx] does not appear in the point cloud, a default value thereof is −1.

Attribute information enable flag field (multi_set_flag[attrIdx]): It is a binary variable. A value of ‘1’ indicates that enabling an attribute determined by the attribute index attrIdx may allow for use of multiple sets of attribute information. a value of ‘0’ indicates that disabling an attribute determined by the attribute index attrIdx allows for use of multiple sets of attribute information, and only one set of attribute information may be used for the attribute data. When multi_set_flag[attrIdx] does not appear in a code stream, a default value thereof is zero.

Attribute information number minus one field (attribute_info_num_set_minus1[attrIdx]): It is an unsigned integer. Plus 1 indicates a quantity of attribute information supported by an attribute determined by the attribute index attrIdx in a point cloud code stream, which is a figure between 0 and 127. When attribute_info_num_set_minus1[attrIdx] does not appear in the code stream, a default value thereof is −1.

Attribute encoding mode flag field (transform): It is an unsigned integer between 0 and 2, and is configured for controlling an attribute encoding mode. When the value is ‘0’, an attribute is encoded through an attribute prediction mode. When the value is ‘1’, the attribute is encoded through a multi-layer transformation mode. When the value is ‘2’, the attribute is encoded through an attribute prediction and transformation mode.

Attribute transformation precision value (kFracBits): It is an unsigned integer, and is configured for indicating shift precision of a fixed-point operation during attribute transformation.

Attribute transformation coefficient QP difference field (attrTransformQpDelta): It is an unsigned integer, and is configured for indicating a difference between the attribute transformation coefficient QP and an attribute residual QP. The attribute transformation coefficient QP attrTransformQp is equal to attrQuantParam+attrTransformQpDelta.

Attribute transformation point number field (attrTransformNumPoints): It is an unsigned integer, and is configured for indicating a number of points of attribute transformation, namely wavelet transform using attrTransformNumPoints. When attrTransformNumPoints=0, wavelet transform is performed through all points in a slice.

Logarithm value of the maximum number of neighbor search points minus seven fields (maxNumOfNeighbour_log2_minus7): It is an unsigned integer, and is configured for exporting a variable maxNumOfNeighbour, and indicates a maximum encoded neighbor number that may be configured for searching to control a search range of a neighbor candidate point and a number of points cached by hardware during attribute prediction. The variable maxNumOfNeighbour is calculated through the following equation maxNum OfNeighbour=^{(maxNumOfNeighbor_log2_minus7+7)}, maxNumOfNeighbour_log2_minus7 being an integer between 0 and 3.

Attribute residual secondary prediction field (cross_component_pred): It is a binary variable. A value of ‘1’ indicates that attribute residual secondary prediction is allowed, and a value of ‘0’ indicates that attribute residual secondary prediction is not allowed.

Residual encoding order switch field (orderSwitch): It is a binary variable. A value of ‘1’ indicates that a residual encoding order is a UYV/GRB order, and a value of ‘0’ indicates that the residual encoding order is a YUV/RGB order.

Chrominance channel Cb QP offset field (chromaQpOffsetCb): It is a signed integer, and is configured for controlling a Cb channel QP with a value range of −16 to 16. If chromaQpOffsetCb is not present in an attribute header, a value of chromaQpOffsetCb is 0, namely choramQpCb=Clip3(minQP,maxQP,attribute_qp+chromaQpOffsetCb). A QP lumaQp of a luminance channel is equal to attribute_qp, a minimum supported QP minQP is equal to 0, and a maximum supported QP maxQP is equal to 63.

Chrominance channel Cr QP offset field (chromaQpOffsetCr): It is a signed integer, and is configured for controlling a Cr channel QP with a value range of −16 to 16. If chromaQpOffsetCr is not present in the attribute header, a value of chromaQpOffsetCr is 0, namely choramQpCr=Clip3(minQP,maxQP,attribute_qp+chromaQpOffsetCr). A QP lumaQp of the luminance channel is equal to attribute_qp, a minimum supported QP minQP is equal to 0, and a maximum supported QP maxQP is equal to 63.

Nearest neighbor prediction parameter 1 field (nearestPredParam1): It is an unsigned integer, and is configured for controlling a threshold for nearest neighbor prediction.

Nearest neighbor prediction parameter 2 field (nearestPredParam2): It is an unsigned integer, and is configured for controlling a threshold for nearest neighbor prediction. The threshold for nearest neighbor prediction is represented as attrQuantParam*nearestPredParam1+nearestPredParam2.

Spatial bias coefficient field (axisBias): It is an unsigned integer, and is configured for controlling an offset in a Z direction during calculation of attribute prediction information.

Attribute output bit depth minus 1 field (outputBitDepthMinus1): It is an unsigned integer, and is configured for controlling an attribute output bit depth, the value being between 0 and 15. The attribute output bit depth outputBitDepth is equal to outputBitDepthMinus1+1. If the syntax element is not in the code stream, a default value is zero.

Number of levels of detail (LOD) field (numOflevelOfDetail): It is an unsigned integer, and is configured for controlling a number of LODs divided during attribute prediction. The numOflevelOfDetail in the code stream conforming to this section is not to be greater than 32.

Maximum number of selected neighbors for prediction field (maxNumOfPredictNeighbours): It is an unsigned integer, and is configured for limiting a number of selected neighbors during attribute prediction. The field maxNumOfPredictNeighbours in a point cloud code stream is not to be greater than 16.

LOD intra-layer prediction flag field (intraLodFlag): It is a binary variable, and is configured for controlling whether to enable intra-layer prediction. When a value is ‘1’, intra-layer prediction is enabled, and when the value is ‘0’, intra-layer prediction is disabled.

Parity-based attribute information flag field (parityBasedLevelCodingEnable): It is a binary variable, and is configured for controlling whether to enable encoding of a parity-based attribute residual or a transformation coefficient. When a value is ‘l’, the encoding is enabled, and when the value is ‘0’, the encoding is disabled.

Color reordering mode field (colorReorderMode): It is an unsigned integer, and is configured for indicating a reordering mode selected by current color information. ‘0’ indicates an original point cloud input order, ‘1’ indicates Hilbert reordering, and ‘2’ indicates Morton reordering.

Reflectance reordering mode field (reflReorderMode): It is an unsigned integer, and is configured for indicating a reordering mode selected by current reflectance information. ‘0’ indicates an original point cloud input order, ‘1’ indicates Hilbert reordering, and ‘2’ indicates Morton reordering.

Maximum cache limit parameter field (log2maxNumofCoeffMinus8): It is an unsigned integer between 0 and 16. The maximum cache limit parameter maxNumofCoeff of a transformation coefficient is calculated through the following equation: maxNumofCoeff=1 << (log2maxNumofCoeffMinus8+8). When log2maxNumofCoeffMinus8 does not appear in the code stream, maxNumofCoeff is 1 by default.

Maximum latency limit parameter field (log2coeffLengthControlMinus8): It is an unsigned integer, and is configured for limiting a maximum number of latencies of a transformation parameter during attribute transformation encoding. In an example, a maximum latency point number is calculated as

$$maxLatency = maxNumofCoeff * ( 1 ≪ ( log 2 coeffLengthControlMinus 8 + 8 ) ) . A maximum value of maxLatency is 131072.$$

Attribute encoding order field (attrEncodeOrder): It is a binary variable, and is configured for controlling an encoding order of attributes when a point cloud includes multiple attribute types. A value of ‘0’ indicates that a color is first encoded and then a reflectance is encoded, and a value of ‘1’ indicates that the reflectance is first encoded and then the color is encoded.

Adaptive exponential Golomb encoding sliding window size field (log2_golomb_group_size): It is an unsigned integer, which indicates a logarithmic value of an adaptive exponential Golomb encoding sliding window size of an attribute prediction residual or a transformation coefficient. The adaptive exponential Golomb encoding sliding window size is expressed as: golomb_sliding_window size=2^{log2_golomb_group_size}.

Cross-type attribute prediction field (crossAttrTypePred): It is a binary variable. A value of ‘1’ indicates that cross-type attribute prediction is allowed, and a value of ‘0’ indicates that the cross-type attribute prediction is not allowed. The cross-type attribute prediction means that different attribute types depend on each other for attribute prediction. For example, attribute prediction is performed for a post-prediction attribute type through a pre-prediction attribute type.

Cross-type attribute prediction weight parameter 1 (crossAttrTypePredParam1): It is a 15-bit unsigned integer, and is configured for controlling a weight parameter 1 for calculating a geometry information distance and an attribute information distance during cross-type attribute prediction.

Cross-type attribute prediction weight parameter 2 (crossAttrTypePredParam2): It is a 21-bit unsigned integer, and is configured for controlling a weight parameter 2 for calculating a geometry information distance and an attribute information distance during cross-type attribute prediction.

Reflectance group prediction flag field (refGroupPred): It is a binary variable, and is configured for controlling whether to enable a reflectance group prediction mode of prediction transformation. A value of ‘1’ indicates that group prediction is enabled, and a value of ‘0’ indicates that group prediction is disabled.

Color initial prediction and transform ratio (colorInitPredTransRatio): It is a signed integer, and is used in a multi-layer transformation algorithm of attribute compression (transform=1) to control a magnitude of an initial distance threshold used by a color during construction of a prediction and transformation tree.

Reflectance initial prediction and transformation ratio (refInitPredTransRatio): It is a signed integer, and is used in a multi-layer transformation algorithm of attribute compression (transform=1) to control a magnitude of an initial distance threshold used by a reflectance during construction of a prediction and transformation tree.

Transformation residual layer flag field (transResLayer): It is a binary variable, and is used in a multi-layer transformation algorithm of attribute compression (transform=1) to control whether to use attribute residual compensation. When transResLayer is equal to 1, attribute residual compensation is used, and when transResLayer is equal to 0, attribute residual compensation is not used.

Color exponential Golomb order (ColorGolombNum): It is an unsigned integer between 0 and 8, and is configured for indicating that a K-order exponential Golomb order K is equal to ColorGolombNum K=ColorGolombNumwhen a current color prediction residual or a transformation coefficient is decoded.

Reflectance exponential Golomb order (RefGolombNum): It is an unsigned integer between 0 and 8, and is configured for indicating that a K-order exponential Golomb order K is equal to RefGolombNum K=ColorGolomb Numwhen a current reflectance prediction residual or a transformation coefficient is decoded.

Decoding mode flag field of a current to-be-decoded coefficient (coeffEncodeModeFlag): It is a binary variable. A value of ‘1’ indicates that a point cloud attribute transformation coefficient is decoded based on a first decoding mode, and A value of ‘0’ indicates that a point cloud attribute transformation coefficient is decoded based on a second decoding mode.

Point cloud adaptive quantization tool flag field (colorQPAdjustFlag): It is a binary variable. A value of ‘0’ indicates that a point cloud adaptive quantization tool is disabled, and a value of ‘1’ indicates that a point cloud adaptive quantization tool is enabled.

Ratio of point numbers before and after point cloud geometry quantization (colorQPAdjustScalar): It is an unsigned integer, and is configured for calculating a distance threshold of a point cloud adaptive quantization tool.

Reflectance attribute prediction precision value (predFixedPointFracBit): It is an unsigned integer, and is configured for indicating shift precision of a fixed-point operation during reflectance attribute prediction. When predFixedPointFracBit is equal to 0, it indicates that the fixed-point operation is not used.

Attribute value variation statistics window size (log2_pred_dist_weight_group_size): It is an unsigned integer, and is configured for controlling a size of an attribute value variation statistics window. The window size is calculated as

$$N = {2}^{log 2 \_ pred \_ dist \_ weight \_ group \_ size} .$$

The foregoing content describes syntax elements of a general attribute header of a point cloud frame. The decoding indication information set in an attribute header of the point cloud frame is described below.

(1) Decoding indication information regarding cross-type attribute prediction:

The decoding indication information may include an attribute presence flag field (attributePresentFlag[attrIdx]) under N attribute types, N representing a quantity of attribute indexes (attrIdx), and N being an integer greater than or equal to 2. The attribute presence flag field under any attribute type is configured for indicating a presence status of an attribute code of the point cloud frame under the corresponding attribute type. If the attribute presence flag field under any attribute type is a first numerical value (for example, the first numerical value may be 0), it may indicate that no attribute code under the corresponding attribute type is present in the point cloud frame. If the attribute presence flag field under any attribute type is a second numerical value (for example, the second numerical value may be 1), it may indicate that an attribute code under the corresponding attribute type is present in the point cloud frame. For example, attrIdx=0 indicates a color attribute type, attrIdx=1 indicates a reflectance attribute type, attributePresentFlag[0]=0 indicates that no attribute code of the color attribute type is present in the point cloud frame, attributePresentFlag[0]=1 indicates that an attribute code of the color attribute type is present in the point cloud frame, attributePresentFlag[1]=0 indicates that no attribute code of the reflectance attribute type is present in the point cloud frame, and attributePresentFlag[1]=1 indicates that an attribute code of the reflectance attribute type is present in the point cloud frame. If attribute presence flag fields under at least two attribute types in N attribute types are the second numerical value (i.e., attribute codes of at least two attribute types in N attribute types are present in the point cloud frame), and the point cloud frame allows cross-type attribute prediction to be performed, the decoding indication information further includes a cross-type attribute prediction parameter (including a cross-type attribute prediction weight parameter 1 (crossAttrTypePredParam1) and a cross-type attribute prediction weight parameter 2 (crossAttrTypePredParam2)). In other words, attribute presence flag fields under N attribute types may be first parsed. After it is determined that attribute presence flag fields under at least two attribute types in N attribute types are the second numerical value, and the point cloud frame allows the cross-type attribute prediction to be performed, the cross-type attribute prediction parameter is parsed. The cross-type attribute prediction parameter is configured for performing attribute decoding indication regarding the cross-type attribute prediction on the point cloud frame, which may be reflected in the attribute headers shown in Table 3 and Table 4 below:

TABLE 3

| | Descriptor |
|---|---|
| attribute_header( ) { | |
| for (attrIdx = 0;attrIdx<(maxNumAttributesMinus1+1);attrIdx++){ | |
| attributePresentFlag[attrIdx] | u(1) |
| } | |
| for (attrIdx = 0;attrIdx<(maxNumAttributesMinus1 + 1);attrIdx++){ | |
| if(attributePresentFlag[attrIdx]){ | |
| attribute_data_num_set_minus1[attrIdx] | ue(v) |
| ... | |
| if (attributePresentFlag[0]&&attributePresentFlag[1]){ | |
| crossAttrTypePred[i] | u(1) |
| if(crossAttrTypePred[i]){ | |
| attrEncodeOrder[i] | u(1) |
| crossAttrTypePredParam1[i] | u(15) |
| crossAttrTypePredParam2[i] | u(21) |
| } | |
| } | |
| ... | |
| } | |
| } | |

A parsing process of the decoding indication information in the attribute headers shown in the foregoing Table 3 is that attribute presence flag fields under N attribute types are first parsed. After it is determined that attribute presence flag fields under at least two attribute types in N attribute types are the second numerical value (for example, attributePresentFlag[0]=1&&attributePresentFlag[1]=1), a cross-type attribute prediction field (crossAttrTypePred) is parsed. If the cross-type attribute prediction field is a second numerical value (crossAttrTypePred=1), it may indicate that the point cloud frame allows cross-type attribute prediction to be performed, and then the cross-type attribute prediction parameters (crossAttrTypePredParam1 and crossAttrTypePredParam2) are parsed. In this case, by default, the corresponding cross-type attribute prediction parameter is adopted only when attribute prediction is performed for a post-prediction attribute type.

TABLE 4

| | Descriptor |
|---|---|
| attribute_header( ){ | |
| for(attrIdx=0;attrIdx<(maxNumAttributesMinus1+1);attrIdx++){ | |
| attributePresentFlag[attrIdx] | u(1) |
| if(attributePresentFlag[attrIdx]){ | |
| attribute_data_num_set_minus1[attrIdx] | ue(v) |
| if(sps_multi_set_flag) | |
| attribute_info_num_set_minus1[attrIdx] | ue(v) |
| for(i=0;i<(attribute_info_num_set_minus1[attrIdx]+1);i++){ | |
| outputBitDepthMinus1[attrIdx][i] | ue(v) |
| maxNumOfNeighboursLog2Minus7[attrIdx][i] | u(2) |
| maxNumOfPredictNeighbours[attrIdx][i] | ue(v) |
| intraLodFlag[attrIdx][i] | u(1) |
| numOflevelOfDetail[attrIdx][i] | ue(v) |
| parityBasedLevelCodingEnable[attrIdx][i] | u(1) |
| log2_golomb_group_size[attrIdx][i] | ue(v) |
| if(attrIdx==0){ | |
| cross_component_Pred[i] | u(1) |
| orderSwitch[i] | u(1) |
| chromaQpOffsetCb[i] | se(v) |
| chromaQpOffsetCr[i] | se(v) |
| colorReorderMode[i] | ue(v) |
| colorGolombNum[i] | ue(v) |
| } | |
| if(attrIdx==1){ | |
| nearestPredParam1[i] | ue(v) |
| nearestPredParam2[i] | ue(v) |
| axisBias[i] | ue(v) |
| refReorderMode[i] | ue(v) |
| refGolombNum[i] | ue(v) |
| predFixedPointFracBit[i] | ue(v) |
| log2_pred_dist_weight_group_size[i] | ue(v) |
| } | |
| transform[attrIdx][i] | ue(2) |
| if(transform[attrIdx][i]==1){ | |
| kFracBits[attrIdx][i] | ue(v) |
| attrTransformQpDelta[attrIdx][i] | ue(v) |
| transformSegmentSize[attrIdx][i] | ue(v) |
| transResLayer[attrIdx][i] | u(1) |
| if(attrIdx==0){ | |
| colorInitPredTransRatio[i] | se(v) |
| } | |
| if(attrIdx==1){ | |
| refInitPredTransRatio[i] | ue(v) |
| } | |
| } | |
| if(transform[attrIdx][i]==2){ | |
| log2maxNumofCoeffMinus8[attrIdx][i] | ue(v) |
| QpOffsetDC[attrIdx][i] | se(v) |
| QpOffsetAC[attrIdx][i] | se(v) |
| if(attrIdx==0){ | |
| colorMaxTransNum[i] | ue(v) |
| chromaQpOffsetDC[i] | se(v) |
| chromaQpOffsetAC[i] | se(v) |
| colorQPAdjustFlag[i] | u(1) |
| if(colorQPAdjustFlag[i]){ | |
| colorQPAdjustScalar[i] | ue(v) |
| } | |
| } | |
| if(attrIdx==1){ | |
| refMaxTransNum[i] | ue(v) |
| RefGroupPred[i] | ae(v) |
| } | |
| } | |
| log2coeffLengthControlMinus8[attrIdx][i] | ue(v) |
| } | |
| } | |
| } | |
| if(attributePresentFlag[0]&&attributePresentFlag[1]){ | |
| crossAttrTypePred | u(1) |
| if(crossAttrTypePred){ | |
| attrEncodeOrder | u(1) |
| crossAttrTypePredParam1 | u(15) |
| crossAttrTypePredParam2 | u(21) |
| } | |
| } | |
| byte_alignment( ) | |
| } | |

A parsing process of the decoding indication information in the attribute headers shown in the foregoing Table 4 is that After the attribute presence flag fields under N attribute types are parsed, and it is determined that attribute presence flag fields under at least two attribute types in N attribute types are the second numerical value (for example, attributePresentFlag[0]=1&&attributePresentFlag[1]=1), a cross-type attribute prediction field (crossAttrTypePred) is parsed. If the cross-type attribute prediction field is a second numerical value (crossAttrTypePred=1), it may indicate that the point cloud frame allows cross-type attribute prediction to be performed, and then the cross-type attribute prediction parameters (crossAttrTypePredParam 1 and crossAttrTypePredParam2) are parsed. In this case, by default, the corresponding cross-type attribute prediction parameter is adopted only when attribute prediction is performed for a post-prediction attribute type.

In an implementation, the decoding indication information may further include an attribute encoding order field (attrEncodeOrder), and the attribute encoding order field may be configured for determining a pre-coding attribute type of a point cloud frame and a post-coding attribute type of the point cloud frame. For example, attrEncodeOrder=0 indicates that the pre-coding attribute type is a color attribute type, and the post-coding attribute type is a reflectance attribute type, and attrEncodeOrder=1 indicates that the pre-coding attribute type is the reflectance attribute type, and the post-coding attribute type is the color attribute type. In this case, the cross-type attribute prediction parameter may include a cross-type attribute prediction parameter of the post-coding attribute type. In other words, after it is determined through parsing that attribute presence flag fields under at least two attribute types in N attribute types are the second numerical value, and the point cloud frame allows the cross-type attribute prediction to be performed, the attribute encoding order field is parsed to determine a pre-coding attribute type and a post-coding attribute type of the point cloud frame, and a corresponding cross-type attribute prediction parameter is adopted during the attribute prediction for the post-coding attribute type, which may be reflected in the attribute headers shown in Table 5 below:

TABLE 5

| attribute_header( ){ | Descriptor |
|---|---|
| for(attrIdx=0;attrIdx<(maxNumAttributesMinus1+1); attrIdx++){ | |
| attributePresentFlag[attrIdx] | u(1) |
| for(attrIdx=0;attrIdx<(maxNumAttributesMinus1+1); attrIdx++){ | |
| if(attributePresentFlag[attrIdx]){ | |
| attribute_data_num_set_minus1[attrIdx] | ue(v) |
| ... | |
| if(attributePresentFlag[0]&&attributePresentFlag[1]){ | |
| crossAttrTypePred[i] | u(1) |
| if(crossAttrTypePred[i]){ | |
| attr EncodeOrder [i] | u(1) |
| if(!attrEncodeOrder[i]&&attrIdx==1){ | |
| crossAttrTypePredParam1[i] | u(15) |
| crossAttrTypePredParam2[i] | u(21) |
| } | |
| if(attrEncodeOrder[i]&&attrIdx==0){ | |
| crossAttrTypePredParam1[i] | u(15) |
| crossAttrTypePredParam2[i] | u(21) |
| } | |
| } | |
| } | |
| ... | |
| } | |
| } | |

A parsing process of the decoding indication information in the attribute headers shown in the foregoing Table 5 is that after it is determined through parsing that the point cloud frame allows the cross-type attribute prediction to be performed, an attribute encoding order field (attrEncodeOrder) may be parsed. If attrEncodeOrder is equal to 0, it may be determined that the pre-coding attribute type is a reflectance attribute type, and the post-coding attribute type is a reflectance attribute type, and cross-type attribute prediction parameters (crossAttrTypePredParam1 and crossAttrTypePredParam2) of the reflectance attribute type may be parsed.

In an implementation, the decoding indication information may further include an index flag field (crossAttrPredictorIndex) of the cross-type attribute prediction. The index flag field for the cross-type attribute prediction may be configured for indicating an attribute information index value under a pre-prediction attribute type adopted when the cross-type attribute prediction is performed for a post-prediction attribute type. In other words, after it is determined through parsing that attribute presence flag fields under at least two attribute types in N attribute types are the second numerical value, and the point cloud frame allows the cross-type attribute prediction to be performed, the index flag field (crossAttrPredictorIndex) of cross-type attribute prediction is parsed to determine an attribute information index value under the pre-prediction attribute type adopted when the cross-type attribute prediction is performed for the post-prediction attribute type. For example, in this case, a cross-type attribute prediction field of the pre-prediction attribute type is a first numerical value (crossAttrTypePred=0), indicating that the point cloud frame does not allow the cross-type attribute prediction to be performed. A cross-type attribute prediction field of the post-prediction attribute type is a second numerical value (crossAttrTypePred=1), indicating that the point cloud frame allows the cross-type attribute prediction to be performed. For example, the pre-prediction attribute type is a color attribute type, and the post-prediction attribute type is a reflectance attribute type. When the cross-type attribute prediction is performed on a reflectance attribute, the index flag field (crossAttrPredictorIndex) for the cross-type attribute prediction may be parsed to determine a color component under the color attribute type to be adopted to perform the cross-type attribute prediction, which may be reflected in the attribute headers shown in Table 6 below:

TABLE 6

| attribute_header( ) { | Descriptor |
|---|---|
| for (attrIdx = 0;attrIdx<(maxNumAttributesMinus1 + 1); attrIdx ++){ | |
| attributePresentFlag[attrIdx] | u(1) |
| } | |
| for (attrIdx = 0;attrIdx<(maxNumAttributesMinus1 + 1); attrIdx ++){ | |
| if(attributePresentFlag[attrIdx]){ | |
| attribute_data_num_set_minus1[attrIdx] | ue(v) |
| ... | |
| if (attributePresentFlag[0]&&attributePresentFlag[1]){ | |
| crossAttrTypePred [i] | u(1) |
| if (crossAttrTypePred[i]){ | |
| crossAttrPredictor Index [i] | ue(v) |
| crossAttrTypePredParam1 [i] | u(15) |
| crossAttrTypePredParam2 [i] | u(21) |
| } | |
| } | |
| ... | |
| } | |
| } | |

In an implementation, the cross-type attribute prediction parameter may be indicated through an attribute type index field (attrIdx) and an attribute information index field under an attribute type. The attribute type index field (attrIdx) and the attribute information index field under the attribute type may indicate which attribute type the cross-type attribute prediction parameter belongs to, and which attribute information under the attribute type uses the cross-type attribute prediction parameter during the cross-type attribute prediction, which may be reflected in the attribute headers shown in Table 7 below:

TABLE 7

| attribute_header( ) { | Descriptor |
|---|---|
| for (attrIdx = 0;attrIdx<(maxNumAttributesMinus1 + 1); attrIdx ++){ | |
| attributePresentFlag[attrIdx] | u(1) |
| } | |
| for (attrIdx = 0;attrIdx<(maxNumAttributesMinus1 + 1); attrIdx ++){ | |
| if(attributePresentFlag[attrIdx]){ | |
| attribute_data_num_set_minus1[attrIdx] | ue(v) |
| ... | |
| if (attributePresentFlag[0]&&attributePresentFlag[1]){ | |
| crossAttrTypePred [attrIdx][i] | u(1) |
| if (crossAttrTypePred [attrIdx] [i]){ | |
| attrEncodeOrder [attrIdx] [i] | u(1) |
| crossAttrTypePredParam1 [attrIdx] [i] | u(15) |
| crossAttrTypePredParam2 [attrIdx] [i] | u(21) |
| } | |
| } | |
| ... | |
| } | |
| } | |

In the foregoing attribute headers shown in Table 7, crossAttrTypePredParam 1[attrIdx][i] indicates that the cross-type attribute prediction parameter (crossAttrTypePredParam1) is a cross-type attribute prediction parameter of an i^{th} piece of attribute information under the attrIdx attribute type. Similarly, crossAttrTypePredParam2[attrIdx][i] indicates that the cross-type attribute prediction parameter (crossAttrTypePredParam2) is a cross-type attribute prediction parameter of the i^{th} piece of attribute information under the attrIdx attribute type. The manner of indicating the cross-type attribute prediction parameter through the attribute type index field (attrIdx) and the attribute information index field under the attribute type may be combined with any of the attribute headers shown in Table 1 to Table 6 above.

In an implementation, when the post-coding attribute type includes a plurality of pieces of attribute information, the cross-type attribute prediction parameter may include a cross-type attribute prediction parameter of each piece of attribute information under the post-coding attribute type. In other words, after it is determined through parsing that attribute presence flag fields under at least two attribute types in N attribute types are a second numerical value, and the point cloud frame allows the cross-type attribute prediction to be performed, if the post-coding attribute type includes a plurality of pieces of attribute information, the cross-type attribute prediction parameter of each piece of attribute information under the post-coding attribute type may be successively parsed, which may be reflected in the attribute headers shown in Table 8 below:

TABLE 8

| attribute_header( ){ | Descriptor |
|---|---|
| for(attrIdx=0;attrIdx<(maxNumAttributesMinus1+1);attrIdx++){ | |
| attributePresentFlag[attrIdx] | u(1) |
| } | |
| for(attrIdx=0;attrIdx<(maxNumAttributesMinus1+1); attrIdx++){ | |
| if(attributePresentFlag[attrIdx]){ | |
| attribute_data_num_set_minus1[attrIdx] | ue(v) |
| ... | |
| if (attributePresentFlag[0]&&attributePresentFlag[1]){ | |
| crossAttrTypePred | u(1) |
| if (crossAttrTypePred){ | |
| attrEncodeOrder | u(1) |
| for ( i=0; i< | |
| (attribute_info_num_set_minus1[!attrEncodeOrder]+1); i++){ | |
| crossAttrTypePredParam1[i] | u(15) |
| crossAttrTypePredParam2[i] | u(21) |
| } | |
| } | |
| } | |
| ... | |
| } | |
| } | |

A parsing process of the decoding indication information in the foregoing attribute headers shown in Table 8 is that After it is determined through parsing that the point cloud frame allows the cross-type attribute prediction to be performed, an attribute encoding order field (attrEncodeOrder) may be parsed. If attrEncodeOrder is equal to 1, it may be determined that the pre-coding attribute type is a reflectance attribute type, the post-coding attribute type is a color attribute type, attribute_info_num_set_minus1 [!attrEncodeOrder]+1 indicates a quantity of pieces of attribute information included in the color attribute type, and the cross-type attribute prediction parameters (crossAttrTypePredParam1 and crossAttrTypePredParam2) in each piece of attribute information included in the color attribute type may be successively parsed.

(2) Decoding indication information regarding color space conversion:

The decoding indication information may include an attribute space conversion flag field (e.g., denoted by colorSpaceTransferFlag), and the attribute space conversion flag field may be configured for indicating a conversion status of an attribute space of the point cloud frame. In an example, the attribute space conversion flag field can include a color space transfer flag that is denoted by colorSpaceTransferFlag. If the attribute space conversion flag field is a first numerical value (for example, the first numerical value may be 0), it may indicate that the conversion of the attribute space is not performed on the point cloud frame. If the attribute space conversion flag field is a second numerical value (for example, the second numerical value may be 1), it may indicate that the conversion of the attribute space is performed on the point cloud frame. For example, the point cloud frame is converted from a first color space (an RGB color space) to a second color space (a YUV color space).

In an implementation, the attribute space is a color space, and if the attribute space conversion flag field is the second numerical value (colorSpaceTransferFlag=1), the decoding indication information may further include a frame attribute QP control field. In other words, after the attribute space conversion flag field is parsed as the second numerical value, the frame attribute QP control field is parsed. The frame attribute QP control field may be configured for controlling an attribute QP of the point cloud frame, and the attribute QP of the point cloud frame may be configured for performing attribute decoding indication regarding attribute quantization on the point cloud frame. The frame attribute QP control field includes any one of the following: a color attribute QP offset and an attribute QP offset of each color component. The fields may be reflected in the following code 1:

```
if(colorSpaceTransferFlag){
  chromaQpOffsetCb [i]
  chromaQpOffsetCr [i]
}
```

As shown in the foregoing code 1, an attribute space conversion flag field (colorSpaceTransferFlag) may be parsed. If colorSpaceTransferFlag is equal to 1, it may indicate that the conversion of the attribute space is performed on the point cloud frame. A frame attribute QP control field may be parsed, which may be a frame attribute QP control field of a converted attribute space. In the foregoing code 1, the frame attribute QP control field may include a frame color chrominance Cb attribute QP offset (chromaQpOffsetCb) and a frame color chrominance Cr attribute QP offset (chromaQpOffsetCr). The frame color chrominance Cb attribute QP offset (chromaQpOffsetCb) is a signed integer, which may be configured for controlling a Cb component QP of a frame-level color attribute, and has a value range of −16 to 16. The frame color chrominance Cr attribute QP offset (chromaQpOffsetCr) is a signed integer, which may be configured for controlling a Cr component QP of a frame-level color attribute, and has a value range of −16 to 16.

In an implementation, if the attribute space conversion flag field is a first numerical value (colorSpaceTransferFlag=0), the decoding indication information may further include an attribute residual multiple prediction field (cross_component_Pred). In other words, after the attribute space conversion flag field is parsed as the first numerical value, the attribute residual multiple prediction field may be parsed. The attribute residual multiple prediction field may be configured for indicating a permission status of the point cloud frame for attribute residual multiple prediction. The fields may be reflected in the following code 2:

if(!colorSpaceTransferFlag){
cross_component_Pred [i]
}

As shown in the foregoing code 2, an attribute space conversion flag field (colorSpaceTransferFlag) may be first parsed. If colorSpaceTransferFlag is equal to 0, it may indicate that conversion of an attribute space is not performed on the point cloud frame, and an attribute residual multiple prediction field (cross_component_Pred) may be parsed. The attribute residual multiple prediction field (cross_component_Pred) may be an attribute residual secondary prediction field. The field is a binary variable, a value of‘1’ indicating that attribute residual secondary prediction is allowed, and a value of ‘0’ indicating that the attribute residual secondary prediction is not allowed.

In an implementation, if the attribute space conversion flag field is a first numerical value (colorSpaceTransferFlag=0), the decoding indication information may further include a transformation residual layer flag field (transResLayer). In other words, after the attribute space conversion flag field is parsed as the first numerical value, the transformation residual layer flag field (transResLayer) may be parsed. The transformation residual layer flag field may be configured for controlling a usage status of attribute residual compensation by the point cloud frame when the point cloud frame uses an attribute encoding mode of a multi-layer transformation algorithm. The fields may be reflected in the following code 3:

if(!colorSpaceTransferFlag){
transResLayer[attrIdx][i]
}

As shown in the foregoing code 3, an attribute space conversion flag field (colorSpaceTransferFlag) may be first parsed. If colorSpaceTransferFlag is equal to 0, it may indicate that conversion of an attribute space is not performed on the point cloud frame, and a transformation residual layer flag field (transResLayer) may be parsed. The transformation residual layer flag field (transResLayer) is a binary variable, and may be configured for controlling whether to use attribute residual compensation in the multi-layer transformation algorithm (transform=1) of attribute compression. When transResLayer is equal to 1, it indicates that the attribute residual compensation is used, and when transResLayer is equal to 0, it indicates that the attribute residual compensation is not used.

(3) Decoding indication information regarding an attribute encoding mode and an attribute index:

The decoding indication information may include an attribute encoding mode flag field (transform), and the attribute encoding mode flag field may be configured for indicating an attribute encoding mode of the point cloud frame. The attribute encoding mode flag field (transform) is an unsigned integer between 0 and 2. When transform is equal to 0, it may indicate that the attribute encoding mode of the point cloud frame is an attribute prediction mode. When transform is equal to 1, it may indicate that the attribute encoding mode of the point cloud frame is an attribute transformation mode (for example, a multi-layer transformation mode). When transform is equal to 2, it may indicate that the attribute encoding mode of the point cloud frame is an attribute prediction and transformation mode.

The decoding indication information may further include an attribute type index field (attrIdx), and the attribute type index field may be configured for indicating an attribute type of the point cloud frame. The attribute type index field (attrIdx) is an unsigned integer. When attrIdx is equal to 0, it may indicate that the attribute type of the point cloud frame is a color attribute type, and when attrIdx is equal to 1, it may indicate that the attribute type of the point cloud frame is a reflectance attribute type.

Syntax elements in the attribute header of the point cloud frame may be organized based on the attribute encoding mode flag field and/or the attribute type index field. The fields may be reflected in the attribute headers shown in the foregoing Table 4 and attribute headers shown in the following Table 9:

TABLE 9

| attribute_header( ) { | Descriptor |
|---|---|
| for (attrIdx = 0;attrIdx<(maxNumAttributesMinus1 + 1);attrIdx ++){ | |
| attributePresentFlag[attrIdx] | u(1) |
| if(attributePresentFlag[attrIdx]){ | |
| attribute_data_num_set_minus1[attrIdx] | ue(v) |
| if(sps_multi_set_flag) | |
| attribute_info_num_set_minus1[attrIdx] | ue(v) |
| for(i=0; i< (attribute_info_num_set_minus1[attrIdx]+1); i++){ | |
| outputBitDepthMinus1[ attrIdx ][i] | ue(v) |
| parityBasedLevelCodingEnable[attrIdx][i] | u(1) |
| log2_golomb_group_size[ attrIdx ][i] | ue(v) |
| if (attrIdx == 0) { | |
| orderSwitch [i] | u(1) |
| colorReorderMode [i] | u (1) |
| colorGolombNum [i] | ue(v) |
| } | |
| if (attrIdx == 1) { | |
| axisBias [i] | ue(v) |
| refReorderMode [i] | u (1) |
| refGolombNum [i] | ue(v) |
| } | |
| if (attributePresentFlag[0]&&attributePresentFlag[1]) { | |
| crossAttrTypePred [i] | u(1) |
| if (crossAttrTypePred[i]){ | |
| attrEncodeOrder [i] | u(1) |
| crossAttrTypePredParam1 [i] | u(15) |
| crossAttrTypePredParam2 [i] | u(21) |
| } | |
| } | |
| transform[attrIdx][i] | u(2) |
| if((transform [attrIdx][i]== 0) \|\| (transform [attrIdx][i]== 2)) | |
| maxNumOfNeighboursLog2Minus7[attrIdx][i] | u(2) |
| numOflevelOfDetail[attrIdx][i] | ue(v) |
| maxNumOfPredictNeighbours[attrIdx][i] | ue(v) |
| intraLodFlag[attrIdx][i] | u(1) |
| if (attrIdx == 0) { | |
| cross_component_Pred [i] | u(1) |
| chromaQpOffsetCb [i] | se(v) |
| chromaQpOffsetCr [i] | se(v) |
| } | |
| if(attrIdx == 1){ | |
| nearestPredParam 1 [i] | ue(v) |
| nearestPredParam2 [i] | ue(v) |
| predFixedPointFracBit [i] | ue(v) |
| log2_pred_dist_weight_group_size[i] | ue(v) |
| } | |
| } | |
| if(transform [attrIdx][i]== 1) { | |
| kFracBits[attrIdx][i] | ue(v) |
| attrTransformQpDelta[attrIdx][i] | ue(v) |
| transformSegmentSize[attrIdx][i] | ue(v) |
| transResLayer[attrIdx][i] | u(1) |
| if (attrIdx == 0) { | |
| colorInitPredTransRatio [i] | se(v) |
| } | |
| if (attrIdx == 1) { | |
| refInitPredTransRatio [i] | se(v) |
| } | |
| } | |
| if (transform[attrIdx][i]==2) { | |
| maxTransNum[ attrIdx ][i] | ue(v) |
| log2maxNumofCoeffMinus8[ attrIdx ][i] | ue(v) |
| QpOffsetDC[ attrIdx ][i] | se(v) |
| QpOffsetAC[ attrIdx ][i] | se(v) |
| if (attrIdx == 0) { | |
| colorMaxTransNum[i] | ue(v) |
| chromaQpOffsetDC [i] | se(v) |
| chromaQpOffsetAC [i] | se(v) |
| colorQPAdjustFlag [i] | u(1) |
| if(colorQPAdjustFlag [i]){ | |
| colorQPAdjustScalar [i] | se(v) |
| } | |
| } | |
| if (attrIdx == 1) { | |
| refMaxTransNum [i] | ue(v) |
| RefGroupPred [i] | u(1) |
| } | |
| } | |
| log2coeffLengthControlMinus8[ attrIdx ][i] | ue(v) |
| } | |
| } | |
| } | |
| byte_alignment( ) | |
| } | |

In the attribute headers shown in the foregoing Table 9, attrIdx==0 indicates a 0^{th} attribute type (namely a color type), and transform[attrIdx][i]==0 indicates that an attribute encoding mode of an i^{th} piece of attribute information under an attrIdx attribute type is an attribute prediction encoding mode.

(4) Decoding indication information regarding an attribute QP:

As described above, the decoding indication information may include an attribute presence flag field (attributePresentFlag[attrIdx]) under N attribute types, N representing a quantity of attribute indexes (attrIdx), and N being an integer greater than or equal to 2. The attribute presence flag field under any attribute type may be configured for indicating a presence status of an attribute code of the point cloud frame under the corresponding attribute type. If the attribute presence flag field under any attribute type is a first numerical value (for example, the first numerical value may be 0), it may indicate that no attribute code under the corresponding attribute type is present in the point cloud frame. If the attribute presence flag field under any attribute type is a second numerical value (for example, the second numerical value may be 1), it may indicate that an attribute code under the corresponding attribute type is present in the point cloud frame. For example, attrIdx=0 indicates a color attribute type, attrIdx=1 indicates a reflectance attribute type, attributePresentFlag[0]=0 indicates that no attribute code of the color attribute type is present in the point cloud frame, attributePresentFlag[0]=1 indicates that an attribute code of the color attribute type is present in the point cloud frame, attributePresentFlag[1]=0 indicates that no attribute code of the reflectance attribute type is present in the point cloud frame, and attributePresentFlag[1]=1 indicates that an attribute code of the reflectance attribute type is present in the point cloud frame.

If an attribute presence flag field under a target attribute type in the N attribute types is the second numerical value, the decoding indication information may further include a frame attribute QP control field under the target attribute type. The frame attribute QP control field under the target attribute type may be configured for controlling an attribute QP of the point cloud frame under the target attribute type, and the attribute QP under the target attribute type may be configured for performing attribute decoding indication regarding attribute quantization under the target attribute type on the point cloud frame.

When the target attribute type is a reflectance attribute, an attribute QP control field under the target attribute type may include a reflectance attribute QP offset field. The fields may be reflected in the following code 4:

if(attributePresentFlag[1]){
reflQpOffset[i]
}

As shown in the foregoing code 4, an attribute presence flag field (attributePresentFlag[1]) under the reflectance attribute type may be first parsed. If attributePresentFlag[1]=1, it may indicate that an attribute code under the reflectance attribute type is present in the point cloud frame, and a reflectance attribute QP offset (reflQpOffset) may be parsed. The reflectance attribute QP offset (reflQpOffset) is a signed integer, which may be configured for controlling an attribute QP of a frame-level reflectance attribute.

When the target attribute type is a color attribute, an attribute QP control field under the target attribute type may include any one of the following: a color attribute QP offset and an attribute QP offset of each color component.

The fields may be reflected in the following code 5 or code 6:

Code 5:
if(attributePresentFlag[0]){
colorQpOffset[i]
}

As shown in the foregoing code 5, an attribute presence flag field (attributePresentFlag[0]) under the color attribute type may be first parsed. If attributePresentFlag[0]=1, it may indicate that an attribute code under the color attribute type is present in the point cloud frame, and a color attribute QP offset (colorQpOffset) may be parsed. The color attribute QP offset (colorQpOffset) is a signed integer, which may be configured for controlling an attribute QP of a frame-level color attribute, may synchronously control each color component under the color attribute, and may be designed as a three-component parameter.

Code 6:
if(attributePresentFlag[0]){
LumaQPOffset[i]
chromaCbQPoffset[i]
chromaCrQPoffset[i]
}

As shown in the foregoing code 6, an attribute presence flag field (attributePresentFlag[0]) under the color attribute type may be first parsed. If attributePresentFlag[0]=1, it may indicate that an attribute code under the color attribute type is present in the point cloud frame, and an attribute QP offset of each color component may be parsed. The attribute QP offset of each color component may include: a frame color luminance attribute QP offset (LumaQPOffset), a frame color chrominance Cb attribute QP offset (chromaCbQPoffset), and a frame color chrominance Cr attribute QP offset (chromaCrQPoffset). The frame color luminance attribute QP offset (LumaQPOffset) is a signed integer, which may be configured for controlling a luminance component QP of a frame-level color attribute, and has a value range of −32 to 32. The frame color chrominance Cb attribute QP offset (chromaCbQPoffset) is a signed integer, which may be configured for controlling a Cb component QP of a frame-level color attribute, and has a value range of −32 to 32. The frame color chrominance Cr attribute QP offset (chromaCrQPoffset) is a signed integer, which may be configured for controlling a Cr component QP of a slice-level color attribute, and has a value range of −32 to 32.

### II. Decoding indication information set in the frame header:

A point cloud may include a plurality of point cloud frames. The decoding indication information may be set in a frame header of each of the point cloud frames. The frame header includes a parameter set required to decode the point cloud frame. The decoding indication information set in the frame header of the point cloud frame may be configured for performing decoding indication on the point cloud frame. The decoding indication information in the frame header is described below with reference to syntax elements of the frame header. For syntax elements of an exemplary frame header, reference may be made to Table 10 below.

TABLE 10

| frame header( ) { | Descriptor |
|---|---|
| frame_idx | ue(v) |
| frame_num_slice_minus_one | ue(v) |
| timestamp_flag | u(1) |
| if(timestamp_flag) { | |
| timestamp | ue(v) |
| } | |
| geom_num_points_upper | u(16) |
| geom_num_points_lower | u(16) |
| byte_alignment( ) | |
| } | |

The syntax elements in the frame header shown in Table 10 above are explained below.

Frame number field (frame_idx): The field indicates a serial number of a point cloud frame in a point cloud sequence, and a value range of the serial number of the point cloud frame is 0 to 65535. A serial number of each point cloud frame is a serial number of a previous point cloud frame plus 1, and a serial number of a first point cloud frame is 0. After a serial number of a certain point cloud frame reaches 65535, a serial number of a next point cloud frame is reset to 0.

Intra-frame point cloud slice number minus one field (frame_num_slice_minus_one): A value of the field is a number of point cloud slices in a point cloud frame minus one.

Timestamp flag field (timestamp_flag): It is a binary variable. A value of ‘0’ indicates that the point cloud frame does not include timestamp information. A value of ‘1’ indicates that the point cloud frame includes timestamp information.

Timestamp field (timestamp): The field indicates the universal time coordinated (UTC).

Frame point number upper bit flag field (geom_num_points_upper): It is a 16-bit number, indicating upper 16 bits of a quantity (a 32-bit unsigned integer) of to-be-decoded points included in a point cloud frame after possible geometric quantization and deduplication.

Frame point number lower bit flag field (geom_num_points_lower): It is a 16-bit number, indicating lower 16 bits of a quantity (a 32-bit unsigned integer) of to-be-decoded points included in a point cloud frame after possible geometric quantization and deduplication.

It may be learned from the foregoing Table 10 that the decoding indication information set in the frame header of the point cloud frame may include a frame point number flag field. The frame point number flag field may be configured for indicating a quantity of to-be-decoded points included in the point cloud frame (which is the quantity of to-be-decoded points included in a point cloud frame after possible geometric quantization and deduplication, the quantity of to-be-decoded points being a 32-bit unsigned integer). In more detail, the frame point number flag field may include a frame point number upper bit flag field (geom_num_points_upper) and a frame point number lower bit flag field (geom_num_points_lower). The frame point number upper bit flag field may be configured for indicating upper bit information of a quantity of to-be- decoded points included in the point cloud frame (which is that the point cloud frame after possible geometric quantization and deduplication includes upper 16 bits of a quantity 32-bit unsigned integer of to-be-decoded points). The frame point number lower bit flag field may be configured for indicating lower bit information of the quantity of to-be-decoded points included in the point cloud frame (which is that the point cloud frame after possible geometric quantization and deduplication includes lower 16 bits of a quantity 32-bit unsigned integer of to-be-decoded points). The quantity of to-be-decoded points included in the point cloud frame may be determined based on the upper bit information and the lower bit information. A specific determining manner is: the quantity (geom_num_points) of to-be-decoded points included in the point cloud frame=(geom_num_points_upper)<<16+geom_num_points_lower.

In addition, the decoding indication information set in the frame header of the point cloud frame may further include a frame slice number flag field (namely an intra-frame point cloud slice number minus one field (frame_num_slice_minus_one)). The frame slice number flag field may be configured for indicating a quantity of point cloud slices included in the point cloud frame. A calculation manner for the quantity of point cloud slices is: the quantity of point cloud slices=frame_num_slice_minus_one+1.

### III. Decoding Indication Information Set in the Slice Header

A point cloud may include a plurality of point cloud frames. The point cloud frames may include a plurality of point cloud slices. The decoding indication information may be set in a slice header of each of the point cloud slices. The slice header includes a parameter set required to decode the point cloud slices. The decoding indication information set in the slice header of the point cloud slice may be configured for performing decoding indication on the point cloud slice. The slice header may include a geometric slice header and an attribute slice header. The decoding indication information may be set in the geometric slice header and the attribute slice header. The geometric slice header includes a parameter set required to decode geometry information of the point cloud slice, and the attribute slice header includes a parameter set required to decode attribute information of the point cloud slice.

(1) The decoding indication information in the geometric slice header is described below with reference to syntax elements of the geometric slice header. For syntax elements of an exemplary geometric slice header, reference may be made to Table 11 below.

TABLE 11

| geometry_slice_header( ) { | Descriptor |
|---|---|
| slice_id | ue(v) |
| ... | |
| slice_num_points_upper | ue(v) |
| marker_bit | f(1) |
| slice_num_points_lower | ue(v) |
| marker_bit | f(1) |
| byte_alignment( ) | |
| } | |

The syntax elements in the geometric slice header shown in the foregoing Table 11 are explained below.

Slice mark number (slice_id): It is an unsigned integer, indicating a mark number

of a slice.

Upper bit of point number included in a slice field (slice_num_points_upper): It is an unsigned integer, indicating upper 16 bits of a quantity (a 32-bit unsigned integer) of to-be-decoded points included in a point cloud slice.

Lower bit of point number included in a slice field (slice_num_points_lower): It is an unsigned integer, indicating lower 16 bits of a quantity (a 32-bit unsigned integer) of to-be-decoded points included in a point cloud slice.

It may be learned from the foregoing Table 11 that the decoding indication information set in the geometric slice header of the point cloud slice may include a slice point number flag field. The slice point number flag field may be configured for indicating a quantity (a 32-bit unsigned integer) of to-be-decoded points included in the point cloud slice. In more detail, the slice point number flag field includes a slice point number upper bit flag field (namely upper bit of point number included in a slice field (slice_num_points_upper)) and a slice point number lower bit flag field (namely lower bit of point number included in a slice field (slice_num_points_lower)). The slice point number upper bit flag field (slice_num_points_upper) may be configured for indicating upper bit information of a quantity of to-be-decoded points included in a point cloud slice (which is upper 16 bits of a quantity (a 32-bit unsigned integer) of to-be-decoded points included in a point cloud slice), and the slice point number lower bit flag field (slice_num_points_lower) may be configured for indicating lower bit information of the quantity of to-be-decoded points included in the point cloud slice (which is lower 16 bits of the quantity (a 32-bit unsigned integer) of to-be-decoded points included in the point cloud slice). The quantity of to-be-decoded points included in the point cloud slice may be determined based on the upper bit information and the lower bit information. A specific determining manner is: a quantity (slice_num_points) of to-be-decoded points included in the point cloud slice=((slice_num_points_upper<<16)+slice_num_points_lower).

(2) The decoding indication information in the attribute slice header is described below with reference to syntax elements of the attribute slice header. For syntax elements of an exemplary attribute slice header, reference may be made to Table 12 below.

TABLE 12

| attribute slice header( ) { | Descriptor |
|---|---|
| slice_id | ue(v) |
| sliceReflQPoffset | se(v) |
| sliceColorQPoffset | se(v) |
| byte_alignment( ) | |
| } | |

The syntax elements in the attribute slice header shown in Table 12 above are explained below.

Slice mark number (slice_id): It is an unsigned integer, indicating a mark number of a slice.

Slice reflectance attribute QP offset (sliceReflQPoffset): It is a signed integer, and is configured for controlling an attribute QP of a slice-level reflectance attribute, and has a value range of −32 to 32.

Slice color luminance attribute QP offset (sliceColorQPoffset): It is a signed integer, and is configured for controlling an attribute QP of a slice-level color attribute, and has a value range of −32 to 32.

For syntax elements of another exemplary attribute slice header, reference may be made to Table 13 below.

TABLE 13

| attribute_slice_header( ) { | Descriptor |
|---|---|
| slice_id | ue(v) |
| sliceReflQPoffset | se(v) |
| sliceLumaQPoffset | se(v) |
| sliceChromaChQPoffset | se(v) |
| sliceChromaCrQPoffset | se(v) |
| byte_alignment( ) | |
| } | |

The syntax elements in the attribute slice header shown in Table 13 above are explained below.

Slice mark number (slice_id): It is an unsigned integer, indicating a mark number of a slice.

Slice reflectance attribute QP offset (sliceReflQPoffset): It is a signed integer, and is configured for controlling an attribute QP of a slice-level reflectance attribute, and has a value range of −32 to 32.

Slice color luminance attribute QP offset (sliceLumaQPoffset): It is a signed integer, and is configured for controlling a luminance component QP of a slice-level color attribute, and has a value range of −32 to 32.

Slice color chrominance Cb attribute QP offset (sliceChromaCbQPoffset): It is a signed integer, and is configured for controlling a Cb component QP of a slice-level color attribute, and has a value range of −32 to 32.

Slice color chrominance Cr attribute QP offset (sliceChromaCrQPoffset): It is a signed integer, and is configured for controlling a Cr component QP of a slice-level color attribute, and has a value range of −32 to 32.

It may be learned from the foregoing Table 12 and Table 13 that the decoding indication information set in the attribute slice header of the point cloud slice may include a slice attribute QP control field. The slice attribute QP control field may be configured for controlling an attribute QP of the point cloud slice. The attribute QP of the point cloud slice may be configured for performing attribute decoding indication regarding attribute quantization on the point cloud slice. The slice attribute QP control field may include: a slice reflectance attribute QP control field (namely a slice reflectance attribute QP offset (sliceReflQPoffset)) and a slice color attribute QP control field (namely a slice color luminance attribute QP offset (sliceColorQPoffset)). Alternatively, the slice attribute QP control field may include: a slice reflectance attribute QP control field (namely the slice reflectance attribute QP offset (sliceReflQPoffset)) and a slice color component attribute QP control field (namely a slice color luminance attribute QP offset (sliceLumaQPoffset), the slice color chrominance Cb attribute QP offset (sliceChromaCbQPoffset), and the slice color chrominance Cr attribute QP offset (sliceChromaCrQPoffset)).

S302: Decode a point cloud based on decoding indication information.

After the point cloud code stream is obtained, the point cloud may be decoded based on the decoding indication information in the point cloud code stream. In more detail, when the decoding indication information is set in the attribute header of the point cloud frame, attribute decoding may be performed on the point cloud frame based on the decoding indication information set in the attribute header of the point cloud frame. When the decoding indication information is set in the frame header of the point cloud frame, the point cloud frame may be decoded based on the decoding indication information set in the frame header of the point cloud frame. When the decoding indication information is set in the slice header of the point cloud slice, the point cloud slice may be decoded based on the decoding indication information set in the slice header of the point cloud slice.

In the embodiments of this disclosure, the decoding indication information in the point cloud code stream may be configured for performing decoding indication on different types of data in a point cloud, the different types of data including at least one of the following: a point cloud frame and a point cloud slice. Therefore, the point cloud is decoded based on the decoding indication information through a decoding indication function of the decoding indication information for different types of data in a point cloud, to improve decoding performance of the point cloud.

An embodiment of this disclosure provides a point cloud processing method. In the point cloud processing method, a point cloud encoding process is mainly described. The point cloud processing method may be performed by a computer device. The computer device may be the encoding device 201 in the foregoing point cloud processing system. As shown in FIG. 4, the point cloud processing method may include but is not limited to the following operation S401 and operation S402.

S401: Generate decoding indication information, and encode the decoding indication information into a point cloud code stream, the decoding indication information being configured for performing decoding indication on different types of data in a point cloud, the different types of data including at least one of the following: a point cloud frame and a point cloud slice.

The decoding indication information may be configured for performing decoding indication on different types of data in the point cloud. The decoding indication information may be encoded into an attribute header, a frame header, and a slice header of the point cloud code stream. In an example, the decoding indication information encoded into the attribute header may be configured for performing attribute decoding indication on the point cloud frame in the point cloud. The decoding indication information encoded into the frame header may be configured for performing decoding indication on the point cloud frame in the point cloud. The decoding indication information encoded into the slice header may be configured for performing decoding indication on the point cloud slice in the point cloud. A generation processes of the decoding indication information encoded into the attribute header, the frame header, and the slice header is described below.

### I. Decoding Indication Information Encoded Into the Attribute Header

The point cloud may include a plurality of point cloud frames. The decoding indication information may be encoded into an attribute header of each of the point cloud frames, and the decoding indication information encoded into the attribute header of the point cloud frame is configured for performing attribute decoding indication on the point cloud frame.

(1) Decoding indication information regarding cross-type attribute prediction:

The decoding indication information may include an attribute presence flag field (attributePresentFlag[attrIdx]) under N attribute types, N representing a quantity of attribute indexes (attrIdx), and N being an integer greater than or equal to 2. The attribute presence flag field under any attribute type is configured for indicating a presence status of an attribute code of the point cloud frame under the corresponding attribute type. The generation of the decoding indication information may include the following: If no attribute code under any attribute type is present in the point cloud frame, an attribute presence flag field under a corresponding attribute type may be set to a first numerical value (for example, the first numerical value may be 0). If an attribute code under any attribute type is present in the point cloud frame, an attribute presence flag field under a corresponding attribute type may be set to a second numerical value (for example, the second numerical value may be 1). For example, attrIdx=0 indicates a color attribute type, and attrIdx=1 indicates a reflectance attribute type. If no attribute code of a color attribute type is present in the point cloud frame, attributePresentFlag[0] is equal to 0. If an attribute code of the color attribute type is present in the point cloud frame, attributePresentFlag[0] is equal to 1. If no attribute code of a reflectance attribute type is present in the point cloud frame, attributePresentFlag[1] is equal to 0. If an attribute code of the reflectance attribute type is present in the point cloud frame, attributePresentFlag[1] is equal to 1. If the attribute presence flag fields under at least two attribute types in N attribute types are set to the second numerical value, and the point cloud frame allows the cross-type attribute prediction to be performed, a cross-type attribute prediction parameter may be added to the decoding indication information. The cross-type attribute prediction parameter may be configured for performing attribute decoding indication regarding the cross-type attribute prediction on the point cloud frame. In an example, when the attribute presence flag fields under at least two attribute types in N attribute types are set to the second numerical value (for example, attributePresentFlag[0]=1&&attributePresentFlag[1]=1), if it is identified that the point cloud frame allows the cross-type attribute prediction to be performed, a cross-type attribute prediction field (crossAttrTypePred) may be added to the decoding indication information, the cross-type attribute prediction field is set to a second numerical value (crossAttrTypePred=1), and cross-type attribute prediction parameters (crossAttrTypePredParam1 and crossAttrTypePredParam2) may be added to the decoding indication information.

In an implementation, the decoding indication information may further include an attribute encoding order field, and the attribute encoding order field may be configured for determining a pre-coding attribute type of a point cloud frame and a post-coding attribute type of the point cloud frame. The cross-type attribute prediction parameter may include a cross-type attribute prediction parameter of the post-coding attribute type. In an example, after the cross- type attribute prediction field (crossAttrTypePred) is added to the decoding indication information, and the cross-type attribute prediction field is set to the second numerical value (crossAttrTypePred=1), an attribute encoding order field (attrEncodeOrder) may be added to the decoding indication information, a value of the attribute encoding order field (attrEncodeOrder) is determined based on the pre-coding attribute type of the point cloud frame and the post-coding attribute type of the point cloud frame, and a cross-type attribute prediction parameter of the post-coding attribute type of the point cloud frame may be added to the decoding indication information based on the post-coding attribute type of the point cloud frame.

In an implementation, the decoding indication information may further include an index flag field (crossAttrPredictorIndex) of the cross-type attribute prediction. The index flag field for the cross-type attribute prediction may be configured for indicating an attribute information index value under a pre-prediction attribute type adopted when the cross-type attribute prediction is performed for a post-prediction attribute type.

In an implementation, the cross-type attribute prediction parameter may be indicated through an attribute type index field (attrIdx) and an attribute information index field under an attribute type. The attribute type index field (attrIdx) and the attribute information index field under the attribute type may indicate which attribute type the cross-type attribute prediction parameter belongs to, and which attribute information under the attribute type uses the cross-type attribute prediction parameter during the cross-type attribute prediction,

In an implementation, when the post-coding attribute type includes a plurality of pieces of attribute information, the cross-type attribute prediction parameter may include a cross-type attribute prediction parameter of each piece of attribute information under the post-coding attribute type. In an example, after the cross-type attribute prediction field (crossAttrTypePred) is added to the decoding indication information, and the cross-type attribute prediction field is set to a second numerical value (crossAttrTypePred=1), a cross-type attribute prediction parameter of each attribute information under a post-coding attribute type may be added to the decoding indication information.

### (2) Decoding Indication Information Regarding Color Space Conversion:

The decoding indication information may include an attribute space conversion flag field (colorSpaceTransferFlag), and the attribute space conversion flag field may be configured for indicating a conversion status of an attribute space of the point cloud frame. The generation of the decoding indication information may include the following: If attribute space conversion is not performed on the point cloud frame, the attribute space conversion flag field may be set to a first numerical value (colorSpaceTransferFlag=0). If the attribute space conversion is performed on the point cloud frame, the attribute space conversion flag field may be set to a second numerical value (colorSpaceTransferFlag=1).

In an implementation, the attribute space is a color space. If the attribute space conversion flag field is set to a second numerical value (colorSpaceTransferFlag=1), a frame attribute QP control field may be added to the decoding indication information. The frame attribute QP control field may be configured for controlling an attribute QP of the point cloud frame, and the attribute QP of the point cloud frame may be configured for performing attribute decoding indication regarding attribute quantization on the point cloud frame. The frame attribute QP control field may include any one of the following: a color attribute QP offset and an attribute QP offset of each color component.

In an implementation, if the attribute space conversion flag field is set to a first numerical value (colorSpaceTransferFlag=0), an attribute residual multiple prediction field (cross_component_Pred) may be added to the decoding indication information. The attribute residual multiple prediction field may be configured for indicating a permission status of the point cloud frame for attribute residual multiple prediction.

In an implementation, if the attribute space conversion flag field is set to a first numerical value (colorSpaceTransferFlag=0), a transformation residual layer flag field (transResLayer) may be added to the decoding indication information. The transformation residual layer flag field may be configured for controlling a usage status of attribute residual compensation by the point cloud frame when the point cloud frame uses an attribute encoding mode of a multi-layer transformation algorithm.

### (3) Decoding Indication Information Regarding an Attribute Encoding Mode and an Attribute Index:

An attribute encoding mode flag field is added to the decoding indication information, and the attribute encoding mode flag field may be configured for indicating an attribute encoding mode of the point cloud frame. In addition, an attribute type index field is further added to the decoding indication information, and the attribute type index field may be configured for indicating an attribute type of the point cloud frame.

Syntax elements in the attribute header of the point cloud frame may be organized based on the attribute encoding mode flag field and/or the attribute type index field.

### (4) Decoding Indication Information Regarding an Attribute QP:

As described above, the decoding indication information may include an attribute presence flag field (attributePresentFlag[attrIdx]) under N attribute types, N representing a quantity of attribute indexes (attrIdx), and N being an integer greater than or equal to 2. The attribute presence flag field under any attribute type is configured for indicating a presence status of an attribute code of the point cloud frame under the corresponding attribute type. The generation of the decoding indication information may include the following: If no attribute code under any attribute type is present in the point cloud frame, an attribute presence flag field under a corresponding attribute type may be set to a first numerical value (for example, the first numerical value may be 0). If an attribute code under any attribute type is present in the point cloud frame, an attribute presence flag field under a corresponding attribute type may be set to a second numerical value (for example, the second numerical value may be 1). For example, attrIdx=0 indicates a color attribute type, and attrIdx=1 indicates a reflectance attribute type. If no attribute code of a color attribute type is present in the point cloud frame, attributePresentFlag[0] is equal to 0. If an attribute code of the color attribute type is present in the point cloud frame, attributePresentFlag[0] is equal to 1. If no attribute code of a reflectance attribute type is present in the point cloud frame, attributePresentFlag[1] is equal to 0. If an attribute code of the reflectance attribute type is present in the point cloud frame, attributePresentFlag[1] is equal to 1.

If an attribute presence flag field under a target attribute type in the N attribute types is set to the second numerical value, a frame attribute QP control field under the target attribute type may be added to the decoding indication information. The frame attribute QP control field under the target attribute type may be configured for controlling an attribute QP of the point cloud frame under the target attribute type, and the attribute QP under the target attribute type may be configured for performing attribute decoding indication regarding attribute quantization under the target attribute type on the point cloud frame. When the target attribute type is a reflectance attribute, an attribute QP control field under the target attribute type may include a reflectance attribute QP offset (reflQpOffset). When the target attribute type is a color attribute, an attribute QP control field under the target attribute type may include any one of the following: a color attribute QP offset (colorQpOffset), and an attribute QP offset of each color component (a frame color luminance attribute QP offset (LumaQPOffset), a frame color chrominance Cb attribute QP offset (chromaCbQPoffset), and a frame color chrominance Cr attribute QP offset (chromaCrQPoffset)).

### II. Decoding Indication Information Encoded Into the Frame Header

The point cloud may include a plurality of point cloud frames. The decoding indication information may be encoded into a frame header of each of the point cloud frames, and the decoding indication information encoded into the frame header of the point cloud frame is configured for performing decoding indication on the point cloud frame.

The decoding indication information may include a frame point number flag field. The generation of the decoding indication information may include the following: identifying a quantity of to-be-encoded points included in the point cloud frame; and setting a frame point number flag field to the quantity of to-be-encoded points. In more detail, the frame point number flag field may include a frame point number upper bit flag field (geom_num_points_upper) and a frame point number lower bit flag field (geom_num_points_lower). The setting a frame point number flag field to the quantity of the to-be-encoded points may include: splitting the quantity of to-be-encoded points into upper bit information and lower bit information; and setting the frame point number upper bit flag field to upper bit information, and setting the frame point number lower bit flag field to the lower bit information.

In addition, the decoding indication information further includes a frame slice number flag field (frame_num_slice_minus_one). The generation of the decoding indication information may include the following: identifying a quantity of point cloud slices included in the point cloud frame; and setting a frame slice number flag field to the quantity of point cloud slices.

### III. Decoding Indication Information Encoded Into the Slice Header

A point cloud may include a plurality of point cloud frames. The point cloud frames may include a plurality of point cloud slices. The decoding indication information may be encoded into a slice header of each of the point cloud slices. The decoding indication information encoded into the slice header of the point cloud slice may be configured for performing decoding indication on the point cloud slice. The slice header may include a geometric slice header and an attribute slice header. The decoding indication information may be encoded into a geometric slice header and an attribute slice header.

(1) Decoding indication information encoded into the geometric slice header:

The decoding indication information may include a slice point number flag field. The generation of the decoding indication information may include the following: identifying a quantity of to-be-encoded points included in the point cloud slice; and setting the slice point number flag field to the quantity of the to-be-encoded points. In an example, the slice point number flag field may include a slice point number uppers bit flag field (slice_num_points_upper) and a slice point number lower bit flag field (slice_num_points_lower). The setting a slice point number flag field to the quantity of the to-be-encoded points may include: splitting the quantity of to-be-encoded points into upper bit information and lower bit information; and setting the slice point number upper bit flag field to upper bit information, and setting the slice point number lower bit flag field to the lower bit information.

### (2) Decoding Indication Information Encoded Into the Attribute Slice Header:

For the decoding indication information in the attribute slice header, the generating the decoding indication information may include: adding a slice attribute QP control field to the decoding indication information. The slice attribute QP control field may be configured for controlling an attribute QP of the point cloud slice. The attribute QP of the point cloud slice may be configured for performing attribute decoding indication regarding attribute quantization on the point cloud slice. The slice attribute QP control field may include: a slice reflectance attribute QP control field (sliceReflQPoffset) and a slice color attribute QP control field (sliceColorQPoffset). Alternatively, the slice attribute QP control field includes: a slice reflectance attribute QP control field (sliceReflQPoffset) and slice color component attribute QP control fields (sliceLumaQPoffset, sliceChromaCbQPoffset, and sliceChromaCrQPoffset).

S402: Transmit the point cloud code stream to a decoding device, so that the decoding device decodes the point cloud based on the decoding indication information.

In the embodiments of this disclosure, the decoding indication information in the point cloud code stream may be configured for performing decoding indication on different types of data in a point cloud, the different types of data including at least one of the following: a point cloud frame and a point cloud slice. Therefore, the point cloud is decoded based on the decoding indication information through a decoding indication function of the decoding indication information for different types of data in a point cloud, to improve decoding performance of the point cloud.

The method of the embodiments of this disclosure is described in detail above. To better implement the foregoing solutions of the embodiments of this disclosure, correspondingly, an apparatus of the embodiments of this disclosure is provided below.

FIG. 5 is a schematic structural diagram of a point cloud processing apparatus according to an embodiment of this disclosure. The point cloud processing apparatus may be arranged in a computer device provided in an embodiment of this disclosure. The computer device may be the decoding device as referred to throughout the text. The point cloud processing apparatus shown in FIG. 5 may be a computer program (including program code) running in the computer device. The point cloud processing apparatus may be configured to perform part or all of the operations in the method embodiment shown in FIG. 3. Referring to FIG. 5, the point cloud processing apparatus may include the following units:
an obtaining unit 501, configured to obtain a point cloud code stream, the point cloud code stream including decoding indication information, the decoding indication information being configured for performing decoding indication on different types of data in a point cloud, the different types of data including at least one of the following: a point cloud frame and a point cloud slice; and
a processing unit 502, configured to decode the point cloud based on the decoding indication information.

In an implementation, the point cloud includes a plurality of point cloud frames, the decoding indication information is set in an attribute header of the point cloud frame, and the decoding indication information is configured for performing attribute decoding indication on the point cloud frame.

In an implementation, the decoding indication information includes attribute presence flag fields under N attribute types, N being an integer greater than or equal to 2. The attribute presence flag field under any attribute type is configured for indicating a presence status of an attribute code of the point cloud frame under the corresponding attribute type.

If the attribute presence flag field under any attribute type is a first numerical value, it indicates that no attribute code under the corresponding attribute type is present in the point cloud frame.

If the attribute presence flag field under any attribute type is a second numerical value, it indicates that an attribute code under the corresponding attribute type is present in the point cloud frame.

In an implementation, if attribute presence flag fields under at least two attribute types in the N attribute types are the second numerical value, and the point cloud frame allows cross-type attribute prediction to be performed, the decoding indication information further includes a cross-type attribute prediction parameter.

The cross-type attribute prediction parameter is configured for performing attribute decoding indication regarding the cross-type attribute prediction on the point cloud frame.

In an implementation, the decoding indication information further includes an attribute encoding order field, and the attribute encoding order field is configured for determining a pre-coding attribute type of the point cloud frame and a post-coding attribute type of the point cloud frame.

The cross-type attribute prediction parameter includes a cross-type attribute prediction parameter of the post-coding attribute type.

In an implementation, when the post-coding attribute type includes a plurality of pieces of attribute information, the cross-type attribute prediction parameter includes a cross-type attribute prediction parameter of each piece of attribute information under the post-coding attribute type.

In an implementation, the decoding indication information further includes an index flag field for the cross-type attribute prediction, the index flag field for the cross-type attribute prediction being configured for indicating an attribute information index value under a pre-prediction attribute type adopted when the cross-type attribute prediction is performed for a post-prediction attribute type.

In an implementation, the cross-type attribute prediction parameter is indicated through an attribute type index field and an attribute information index field under an attribute type.

In an implementation, if an attribute presence flag field under a target attribute type in the N attribute types is the second numerical value, the decoding indication information further includes a frame attribute QP control field under the target attribute type.

The frame attribute QP control field under the target attribute type is configured for controlling an attribute QP of the point cloud frame under the target attribute type, and the attribute QP under the target attribute type is configured for performing attribute decoding indication regarding attribute quantization under the target attribute type on the point cloud frame.

When the target attribute type is a reflectance attribute, an attribute QP control field under the target attribute type includes a reflectance attribute QP offset. When the target attribute type is a color attribute, an attribute QP control field under the target attribute type includes any one of the following: a color attribute QP offset and an attribute QP offset of each color component.

In an implementation, the decoding indication information includes an attribute space conversion flag field, the attribute space conversion flag field being configured for indicating a conversion status of an attribute space of the point cloud frame.

If the attribute space conversion flag field is a first numerical value, it indicates that conversion of the attribute space is not performed on the point cloud frame.

If the attribute space conversion flag field is a second numerical value, it indicates that the conversion of the attribute space is performed on the point cloud frame.

In an implementation, the attribute space is a color space, and if the attribute space conversion flag field is the second numerical value, the decoding indication information further includes a frame attribute QP control field.

The frame attribute QP control field is configured for controlling an attribute QP of the point cloud frame, and the attribute QP of the point cloud frame is configured for performing attribute decoding indication regarding attribute quantization on the point cloud frame.

The frame attribute QP control field includes any one of the following: a color attribute QP offset and an attribute QP offset of each color component.

In an implementation, if the attribute space conversion flag field is the first numerical value, the decoding indication information further includes an attribute residual multiple prediction field.

The attribute residual multiple prediction field is configured for indicating a permission status of the point cloud frame for attribute residual multiple prediction.

In an implementation, if the attribute space conversion flag field is the first numerical value, the decoding indication information further includes a transformation residual layer flag field.

The transformation residual layer flag field is configured for controlling a usage status of attribute residual compensation by the point cloud frame when the point cloud frame uses an attribute encoding mode of a multi-layer transformation algorithm.

In an implementation, the decoding indication information includes an attribute encoding mode flag field, and the attribute encoding mode flag field is configured for indicating an attribute encoding mode of the point cloud frame.

The decoding indication information further includes an attribute type index field, the attribute type index field being configured for indicating an attribute type of the point cloud frame.

Syntax elements in the attribute header of the point cloud frame are classified and organized based on the attribute encoding mode flag field and/or the attribute type index field.

In an implementation, the point cloud includes a plurality of point cloud frames, the decoding indication information is set in a frame header of the point cloud frame, and the decoding indication information is configured for performing decoding indication on the point cloud frame.

In an implementation, the decoding indication information includes a frame point number flag field. The frame point number flag field is configured for indicating a quantity of to-be-decoded points included in the point cloud frame.

In an implementation, the frame point number flag field includes a frame point number upper bit flag field and a frame point number lower bit flag field. The frame point number upper bit flag field is configured for indicating upper bit information of the quantity of to-be-decoded points included in the point cloud frame, and the frame point number lower bit flag field is configured for indicating lower bit information of the quantity of to-be-decoded points included in the point cloud frame.

The quantity of to-be-decoded points comprised in the point cloud frame is determined based on the upper bit information and the lower bit information.

In an implementation, the decoding indication information includes a frame slice number flag field, the frame slice number flag field being configured for indicating a quantity of point cloud slices included in the point cloud frame.

In an implementation, the point cloud includes a plurality of point cloud frames, the point cloud frames including a plurality of point cloud slices, the decoding indication information being set in a slice header of the point cloud slices, and the decoding indication information being configured for performing decoding indication on the point cloud slices.

In an implementation, the slice header includes a geometric slice header, and the decoding indication information includes a slice point number flag field, the slice point number flag field being configured for indicating a quantity of to-be-decoded points included in the point cloud slice.

In an implementation, the slice point number flag field includes a slice point number upper bit flag field and a slice point number lower bit flag field, the slice point number upper bit flag field being configured for indicating upper bit information of the quantity of to-be-decoded points included in the point cloud slice, and the slice point number lower bit flag field being configured for indicating lower bit information of the quantity of to-be-decoded points included in the point cloud slice.

The quantity of to-be-decoded points included in the point cloud slice is determined based on the upper bit information and the lower bit information.

In an implementation, the slice header includes an attribute slice header, and the decoding indication information includes a slice attribute QP control field, the slice attribute QP control field being configured for controlling an attribute QP of the point cloud slice, the attribute QP of the point cloud slice being configured for performing attribute decoding indication regarding attribute quantization on the point cloud slice.

The slice attribute QP control field includes a slice reflectance attribute QP control field and a slice color attribute QP control field, or the slice attribute QP control field includes a slice reflectance attribute QP control field and a slice color component attribute QP control field.

According to another embodiment of this disclosure, the units in the point cloud processing apparatus shown in FIG. 5 may be separately or all combined into one or several other units, or one (some) of the units may further be split into a plurality of small units in function, which may implement the same operation without affecting the implementation of the technical effects of the embodiments of this disclosure. The foregoing units are divided based on logical functions. In practical application, functions of one unit may also be implemented by a plurality of units, or the functions of the plurality of units may be implemented by one unit. In another embodiment of this disclosure, the point cloud processing apparatus may also include another unit. In actual application, these functions may also be implemented with assistance of another unit, and may be implemented by a plurality of units in collaboration.

According to another embodiment of this disclosure, a computer program (including program code) that can perform some or all of the operations involved in the method shown in FIG. 3 may be run in a general-purpose computing device such as a computer including processing elements and storage elements such as a central processing unit (CPU), a random access medium (RAM), and a read-only storage medium (ROM), to construct the point cloud processing apparatus shown in FIG. 5, thereby implementing the point cloud processing method in the embodiments of this disclosure. The computer program may be recorded on, for example, a computer-readable storage medium, loaded into the foregoing computing device through the computer-readable storage medium, and run in the computing device.

In the embodiments of this disclosure, the decoding indication information in the point cloud code stream may be configured for performing decoding indication on different types of data in a point cloud, the different types of data including at least one of the following: a point cloud frame and a point cloud slice. Therefore, the point cloud is decoded based on the decoding indication information through a decoding indication function of the decoding indication information for different types of data in a point cloud, to improve decoding performance of the point cloud.

FIG. 6 is a schematic structural diagram of a point cloud processing apparatus according to an embodiment of this disclosure. The point cloud processing apparatus may be arranged in a computer device provided in an embodiment of this disclosure. The computer device may be the encoding device as referred to throughout the text. The point cloud processing apparatus shown in FIG. 6 may be a computer program (including program code) running in the computer device. The point cloud processing apparatus may be configured to perform part or all of the operations in the method embodiment shown in FIG. 4. Referring to FIG. 6, the point cloud processing apparatus may include the following units:
a processing unit 601, configured to generate the decoding indication information, and encode the decoding indication information into a point cloud code stream, the decoding indication information being configured for performing decoding indication on different types of data in a point cloud, the different types of data including at least one of the following: a point cloud frame and a point cloud slice; and
a communication unit 602, configured to transmit the point cloud code stream to a decoding device, so that the decoding device decodes the point cloud based on the decoding indication information.

According to another embodiment of this disclosure, the units in the point cloud processing apparatus shown in FIG. 6 may be separately or all combined into one or several other units, or one (some) of the units may further be split into a plurality of small units in function, which may implement the same operation without affecting the implementation of the technical effects of the embodiments of this disclosure. The foregoing units are divided based on logical functions. In practical application, functions of one unit may also be implemented by a plurality of units, or the functions of the plurality of units may be implemented by one unit. In another embodiment of this disclosure, the point cloud processing apparatus may also include another unit. In actual application, these functions may also be implemented with assistance of another unit, and may be implemented by a plurality of units in collaboration.

According to another embodiment of this disclosure, a computer program (including program code) that can perform some or all of the operations involved in the method shown in FIG. 4 may be run in a general-purpose computing device such as a computer including processing elements and storage elements such as a CPU, a RAM, and a ROM, to construct the point cloud processing apparatus shown in FIG. 6, thereby implementing the point cloud processing method in the embodiments of this disclosure. The computer program may be recorded on, for example, a computer-readable storage medium, loaded into the foregoing computing device through the computer-readable storage medium, and run in the computing device.

In the embodiments of this disclosure, the decoding indication information in the point cloud code stream may be configured for performing decoding indication on different types of data in a point cloud, the different types of data including at least one of the following: a point cloud frame and a point cloud slice. Therefore, the point cloud is decoded based on the decoding indication information through a decoding indication function of the decoding indication information for different types of data in a point cloud, to improve decoding performance of the point cloud.

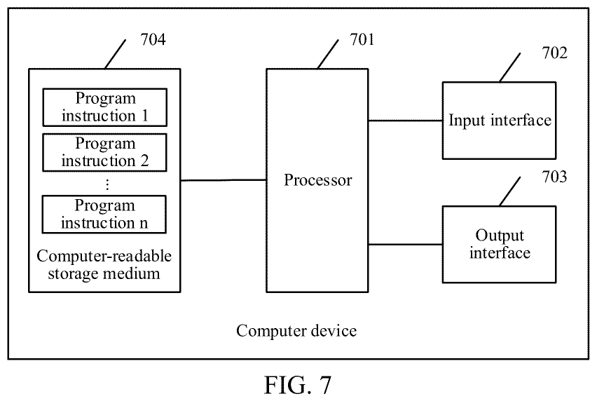

Based on the foregoing method and apparatus embodiments, an embodiment of this disclosure provides a computer device. FIG. 7 is a schematic structural diagram of a computer device according to an embodiment of this disclosure. The computer device shown in FIG. 7 includes at least a processor 701, an input interface 702, an output interface 703, and a computer-readable storage medium 704. The processor 701, the input interface 702, the output interface 703, and the computer-readable storage medium 704 may be connected through a bus or in another manner.

The computer-readable storage medium 704 may be stored in a memory of the computer device. The computer-readable storage medium 704 is configured to store a computer program. The computer program includes a computer instruction. The processor 701 is configured to execute a program instruction stored in the computer-readable storage medium 704. The processor 701 (or referred to as a CPU) is a computing core and a control core of the computer device, which is adapted to implement one or more computer instructions, and adapted to load and execute one or more computer instructions to implement corresponding method processes or corresponding functions.

An embodiment of this disclosure further provides a computer-readable storage medium (memory). The computer-readable storage medium is a memory device in a computer device, which is configured to store a program and data. The computer-readable storage medium herein may include a built-in storage medium in the computer device, and certainly, may also include an extended storage medium supported by the computer device. The computer-readable storage medium provides a storage space. The storage space has an operating system of the computer device stored therein. In addition, one or more computer instructions adapted to be loaded and executed by the processor are further stored in the storage space. The computer instructions may be one or more computer programs (including program code). The computer-readable storage medium herein may be a high-speed RAM, or may be a non-volatile memory, for example, at least one magnetic disk memory. In some embodiments, the computer-readable storage medium may further be at least one computer-readable storage medium away from the foregoing processor.

In some embodiments, the computer device may be a decoding device. The computer device may be loaded by the processor 701 to execute one or more computer instructions stored in the computer-readable storage medium 704, so as to implement the foregoing corresponding operations of the point cloud processing method shown in FIG. 3. During specific implementation, the computer instructions in the computer-readable storage medium 704 are loaded by the processor 701 to perform the following operations:
obtaining a point cloud code stream, the point cloud code stream including decoding indication information, the decoding indication information being configured for performing decoding indication on different types of data in a point cloud, the different types of data including at least one of the following: a point cloud frame and a point cloud slice; and
decoding the point cloud based on the decoding indication information.

In an implementation, the point cloud includes a plurality of point cloud frames, the decoding indication information is set in an attribute header of the point cloud frame, and the decoding indication information is configured for performing attribute decoding indication on the point cloud frame.

In an implementation, the decoding indication information includes attribute presence flag fields under N attribute types, N being an integer greater than or equal to 2. The attribute presence flag field under any attribute type is configured for indicating a presence status of an attribute code of the point cloud frame under the corresponding attribute type.

If the attribute presence flag field under any attribute type is a first numerical value, it indicates that no attribute code under the corresponding attribute type is present in the point cloud frame.

If the attribute presence flag field under any attribute type is a second numerical value, it indicates that an attribute code under the corresponding attribute type is present in the point cloud frame.

In an implementation, if attribute presence flag fields under at least two attribute types in the N attribute types are the second numerical value, and the point cloud frame allows cross-type attribute prediction to be performed, the decoding indication information further includes a cross-type attribute prediction parameter.

The cross-type attribute prediction parameter is configured for performing attribute decoding indication regarding the cross-type attribute prediction on the point cloud frame.

In an implementation, the decoding indication information further includes an attribute encoding order field, and the attribute encoding order field is configured for determining a pre-coding attribute type of the point cloud frame and a post-coding attribute type of the point cloud frame.

The cross-type attribute prediction parameter includes a cross-type attribute prediction parameter of the post-coding attribute type.

In an implementation, when the post-coding attribute type includes a plurality of pieces of attribute information, the cross-type attribute prediction parameter includes a cross-type attribute prediction parameter of each piece of attribute information under the post-coding attribute type.

In an implementation, the decoding indication information further includes an index flag field for the cross-type attribute prediction, the index flag field for the cross-type attribute prediction being configured for indicating an attribute information index value under a pre-prediction attribute type adopted when the cross-type attribute prediction is performed for a post-prediction attribute type.

In an implementation, the cross-type attribute prediction parameter is indicated through an attribute type index field and an attribute information index field under an attribute type.

In an implementation, if an attribute presence flag field under a target attribute type in the N attribute types is the second numerical value, the decoding indication information further includes a frame attribute QP control field under the target attribute type.

The frame attribute QP control field under the target attribute type is configured for controlling an attribute QP of the point cloud frame under the target attribute type, and the attribute QP under the target attribute type is configured for performing attribute decoding indication regarding attribute quantization under the target attribute type on the point cloud frame.

When the target attribute type is a reflectance attribute, an attribute QP control field under the target attribute type includes a reflectance attribute QP offset. When the target attribute type is a color attribute, an attribute QP control field under the target attribute type includes any one of the following: a color attribute QP offset and an attribute QP offset of each color component.

In an implementation, the decoding indication information includes an attribute space conversion flag field, the attribute space conversion flag field being configured for indicating a conversion status of an attribute space of the point cloud frame.

If the attribute space conversion flag field is a first numerical value, it indicates that conversion of the attribute space is not performed on the point cloud frame.

If the attribute space conversion flag field is a second numerical value, it indicates that the conversion of the attribute space is performed on the point cloud frame.

In an implementation, the attribute space is a color space, and if the attribute space conversion flag field is the second numerical value, the decoding indication information further includes a frame attribute QP control field.

The frame attribute QP control field is configured for controlling an attribute QP of the point cloud frame, and the attribute QP of the point cloud frame is configured for performing attribute decoding indication regarding attribute quantization on the point cloud frame.

The frame attribute QP control field includes any one of the following: a color attribute QP offset and an attribute QP offset of each color component.

In an implementation, if the attribute space conversion flag field is the first numerical value, the decoding indication information further includes an attribute residual multiple prediction field.

The attribute residual multiple prediction field is configured for indicating a permission status of the point cloud frame for attribute residual multiple prediction.

In an implementation, if the attribute space conversion flag field is the first numerical value, the decoding indication information further includes a transformation residual layer flag field.

The transformation residual layer flag field is configured for controlling a usage status of attribute residual compensation by the point cloud frame when the point cloud frame uses an attribute encoding mode of a multi-layer transformation algorithm.

In an implementation, the decoding indication information includes an attribute encoding mode flag field, and the attribute encoding mode flag field is configured for indicating an attribute encoding mode of the point cloud frame.

The decoding indication information further includes an attribute type index field, the attribute type index field being configured for indicating an attribute type of the point cloud frame.

Syntax elements in the attribute header of the point cloud frame are classified and organized based on the attribute encoding mode flag field and/or the attribute type index field.

In an implementation, the point cloud includes a plurality of point cloud frames, the decoding indication information is set in a frame header of the point cloud frame, and the decoding indication information is configured for performing decoding indication on the point cloud frame.

In an implementation, the decoding indication information includes a frame point number flag field. The frame point number flag field is configured for indicating a quantity of to-be-decoded points included in the point cloud frame.

In an implementation, the frame point number flag field includes a frame point number upper bit flag field and a frame point number lower bit flag field. The frame point number upper bit flag field is configured for indicating upper bit information of the quantity of to-be-decoded points included in the point cloud frame, and the frame point number lower bit flag field is configured for indicating lower bit information of the quantity of to-be-decoded points included in the point cloud frame.

The quantity of to-be-decoded points comprised in the point cloud frame is determined based on the upper bit information and the lower bit information.

In an implementation, the decoding indication information includes a frame slice number flag field, the frame slice number flag field being configured for indicating a quantity of point cloud slices included in the point cloud frame.

In an implementation, the point cloud includes a plurality of point cloud frames, the point cloud frames including a plurality of point cloud slices, the decoding indication information being set in a slice header of the point cloud slices, and the decoding indication information being configured for performing decoding indication on the point cloud slices.

In an implementation, the slice header includes a geometric slice header, and the decoding indication information includes a slice point number flag field, the slice point number flag field being configured for indicating a quantity of to-be-decoded points included in the point cloud slice.

In an implementation, the slice point number flag field includes a slice point number upper bit flag field and a slice point number lower bit flag field, the slice point number upper bit flag field being configured for indicating upper bit information of the quantity of to-be-decoded points included in the point cloud slice, and the slice point number lower bit flag field being configured for indicating lower bit information of the quantity of to-be-decoded points included in the point cloud slice.

The quantity of to-be-decoded points included in the point cloud slice is determined based on the upper bit information and the lower bit information.

In an implementation, the slice header includes an attribute slice header, and the decoding indication information includes a slice attribute QP control field, the slice attribute QP control field being configured for controlling an attribute QP of the point cloud slice, the attribute QP of the point cloud slice being configured for performing attribute decoding indication regarding attribute quantization on the point cloud slice.

The slice attribute QP control field includes a slice reflectance attribute QP control field and a slice color attribute QP control field, or the slice attribute QP control field includes a slice reflectance attribute QP control field and a slice color component attribute QP control field.

In some other embodiments, the computer device may be a decoding device. The computer device may be loaded by the processor 701 to execute one or more computer instructions stored in the computer-readable storage medium 704, so as to implement the foregoing corresponding operations of the point cloud processing method shown in FIG. 4. During specific implementation, the computer instructions in the computer-readable storage medium 704 are loaded by the processor 701 to perform the following operations:
generating decoding indication information, and encoding the decoding indication information into a point cloud code stream, the decoding indication information being configured for performing decoding indication on different types of data in a point cloud, the different types of data including at least one of the following: a point cloud frame and a point cloud slice; and
transmitting the point cloud code stream to a decoding device, so that the decoding device decodes the point cloud based on the decoding indication information.

In the embodiments of this disclosure, the decoding indication information in the point cloud code stream may be configured for performing decoding indication on different types of data in a point cloud, the different types of data including at least one of the following: a point cloud frame and a point cloud slice. Therefore, the point cloud is decoded based on the decoding indication information through a decoding indication function of the decoding indication information for different types of data in a point cloud, to improve decoding performance of the point cloud.

According to an aspect of this disclosure, a computer program product is provided, the computer program product including a computer instruction, the computer instruction being stored in a computer-readable storage medium. A processor of a computer device reads the computer instruction from the computer-readable storage medium. The processor executes the computer instruction, so that the computer device performs the point cloud processing method provided in foregoing various manners.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely specific implementations of this disclosure, but the protection scope of this disclosure is not limited thereto. Any variation or replacement within the technical scope disclosed in this disclosure shall fall within the protection scope of this disclosure. Therefore, the protection scope of this disclosure is subject to the protection scope of the claims.

What is claimed is:

1. A method of point cloud processing, the method comprising:
obtaining a point cloud code stream of a point cloud having a plurality of point cloud frames, the point cloud code stream comprising decoding indication information that provides decoding information for different element levels of the point cloud, the different element levels of the point cloud comprising at least one of: a point cloud frame level and a point cloud slice level, the decoding indication information including a decoding of a cross-type attribute prediction parameter based on an attribute encoding order field; and
decoding the point cloud code stream based on the decoding indication information.

2. The method according to claim 1, wherein:
a portion of the decoding indication information is set in an attribute header of a point cloud frame in the plurality of point cloud frames, and the portion of the decoding indication information provides attribute decoding indication on the point cloud frame.

3. The method according to claim 2, wherein:
the portion of the decoding indication information comprises respective attribute presence flag fields of N attribute types, N being an integer greater than or equal to 2;
an attribute presence flag field of an attribute type in the N attribute types indicates a presence status of an attribute code of the attribute type for the point cloud frame;
a first numerical value in the attribute presence flag field indicates no attribute code of the attribute type for the point cloud frame; and
a second numerical value in the attribute presence flag field indicates that a presence of the attribute code of the attribute type for the point cloud frame.

4. The method according to claim 3, wherein:
when the attribute presence flag field of the attribute type has the second numerical value and a cross-type attribute prediction is allowed for the point cloud frame, the portion of the decoding indication information further comprises the cross-type attribute prediction parameter for the cross-type attribute prediction of the point cloud frame.

5. The method according to claim 4, wherein:
the portion of the decoding indication information further comprises the attribute encoding order field that indicates a pre-coding attribute type of the point cloud frame and a post-coding attribute type of the point cloud frame; and
the cross-type attribute prediction parameter comprises a cross-type attribute prediction parameter for the post-coding attribute type that is indicted by the attribute encoding order field.

6. The method according to claim 5, wherein:
when the post-coding attribute type comprises a plurality of pieces of attribute information, the cross-type attribute prediction parameter comprises respective cross-type attribute prediction parameters of the plurality of pieces of attribute information of the post-coding attribute type.

7. The method according to claim 4, wherein:
the portion of the decoding indication information further comprises an index flag field of the cross-type attribute prediction, and
the index flag field of the cross-type attribute prediction indicates an attribute information index value of a pre-prediction attribute type that is adopted when the cross-type attribute prediction is performed for a post-prediction attribute type.

8. The method according to claim 4, wherein the cross-type attribute prediction parameter is determined based on an attribute type index field of the attribute type and an attribute information index field of the attribute type.

9. The method according to claim 3, wherein:
when an attribute presence flag field of a target attribute type in the N attribute types has the second numerical value, the portion of the decoding indication information further comprises a frame attribute quantization parameter (QP) control field of the target attribute type that provides attribute quantization information of the target attribute type in the point cloud frame;
when the target attribute type is a reflectance attribute, an attribute QP control field of the reflectance attribute comprises a reflectance attribute QP offset; and
when the target attribute type is a color attribute, an attribute QP control field of the color attribute comprises at least one of: a color attribute QP offset and an attribute QP offset of each color component.

10. The method according to claim 2, wherein:
the portion of the decoding indication information comprises an attribute space conversion flag field, the attribute space conversion flag field being configured for indicating a conversion status of an attribute space of the point cloud frame;
a first numerical value in the attribute space conversion flag field indicates that no conversion of the attribute space is performed on the point cloud frame; and
a second numerical value in the attribute space conversion flag field indicates that a conversion of the attribute space is performed on the point cloud frame.

11. The method according to claim 10, wherein:
the attribute space is a color space;
when the attribute space conversion flag field has the second numerical value, the portion of the decoding indication information further comprises a frame attribute QP control field that provides attribute quantization information of the point cloud frame; and
the frame attribute QP control field comprises at least one of: a color attribute QP offset and an attribute QP offset of each color component.

12. The method according to claim 10, wherein:
when the attribute space conversion flag field has the first numerical value, the portion of the decoding indication information further comprises an attribute residual multiple prediction field that indicates a permission status of attribute residual multiple predictions in the point cloud frame.

13. The method according to claim 10, wherein:
when the attribute space conversion flag field has the first numerical value, the portion of the decoding indication information further comprises a transformation residual layer flag field that controls a usage status of an attribute residual compensation in the point cloud frame when the point cloud frame uses an attribute encoding mode of a multi-layer transformation algorithm.

14. The method according to claim 2, wherein:
the portion of the decoding indication information comprises an attribute encoding mode flag field that indicates an attribute encoding mode of the point cloud frame;
the portion of the decoding indication information further comprises an attribute type index field for indicating an attribute type of the point cloud frame; and
syntax elements in the attribute header of the point cloud frame are classified and organized based on the attribute encoding mode flag field and/or the attribute type index field.

15. The method according to claim 2, wherein:
a frame header of the point cloud frame comprises a portion of the decoding indication information that comprises a frame point number flag field, and
the frame point number flag field indicates a quantity of to-be-decoded points in the point cloud frame.

16. The method according to claim 15, wherein:
the frame point number flag field comprises a frame point number upper bit flag field and a frame point number lower bit flag field,
the frame point number upper bit flag field indicates upper bit information of the quantity of to-be-decoded points in the point cloud frame,
the frame point number lower bit flag field indicates lower bit information of the quantity of to-be-decoded points in the point cloud frame, and
the quantity of to-be-decoded points in the point cloud frame is determined based on the upper bit information and the lower bit information.

17. The method according to claim 2, wherein:
a frame header of the point cloud frame comprises a portion of the decoding indication information that comprises a frame slice number flag field, and
the frame slice number flag field indicates a quantity of point cloud slices in the point cloud frame.

18. The method according to claim 2, wherein:
a slice header of a point cloud slice in the point cloud frame comprises a portion of the decoding indication information that comprises a geometric slice header, and
the geometric slice header comprises a slice point number flag field indicating a quantity of to-be-decoded points in the point cloud slice.

19. The method according to claim 18, wherein:
the slice point number flag field comprises a slice point number upper bit flag field and a slice point number lower bit flag field, the slice point number upper bit flag field indicates upper bit information of the quantity of to-be-decoded points comprised in the point cloud slice, and the slice point number lower bit flag field indicates lower bit information of the quantity of to-be-decoded points in the point cloud slice; and
the quantity of to-be-decoded points comprised in the point cloud slice is determined based on the upper bit information and the lower bit information.

20. A non-transitory computer-readable storage medium storing a bitstream that when processed by a processor causes the processor to perform:
obtaining a point cloud code stream of a point cloud having a plurality of point cloud frames, the point cloud code stream comprising decoding indication information that provides decoding information for different element levels of the point cloud, the different element levels of the point cloud comprising at least one of: a point cloud frame level and a point cloud slice level, the decoding indication information including a decoding of a cross-type attribute prediction parameter based on an attribute encoding order field; and
decoding the point cloud code stream based on the decoding indication information.
